(19) United States
(12) Patent Application Publication
(10) Pub. No.: US 2026/0186987 A1
(43) Pub. Date: Jul. 2, 2026

(54) Memory Sub-System Operable with Multiple Connections for Concurrent Storage Access Communications and Memory Access Communications

(71) Applicant: Micron Technology, Inc., Boise, ID (US)

(72) Inventor: Luca Bert, Bologna (BO) (IT)

(21) Appl. No.: 19/008,300

(22) Filed: Jan. 2, 2025

(51) Int. Cl. G06F 13/16; G06F 13/42

(52) U.S. Cl. CPC G06F 13/1642; G06F 13/1668; G06F 13/4221

(57) ABSTRACT

A memory sub-system having: a plurality of host interfaces operable to communicate concurrently over a plurality of connections respectively; memory cells configured to provide a memory space accessible to a host system via the connections and a storage space separate from the memory space and accessible to the host system via the connections; and a controller configured to communicate with the host system via a first connection, among the plurality of connections, to execute a first request to access the storage space and concurrently communicate with the host system via a second connection, among the plurality of connections, to respond to a second request to access the memory space.

### TECHNICAL FIELD

At least some embodiments disclosed herein relate to memory systems in general, and more particularly, but not limited to memory sub-systems configured to provide both memory and storage.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a memory sub-system having a storage space and a memory space that are both accessible to a host system according to one embodiment.

FIG. 3 shows a technique of using a storage access request to transfer data between a storage space and a memory space of a memory sub-system according to one embodiment.

FIG. 4 shows a technique of using a memory access request for data transferred between a storage space and a memory space of a memory sub-system according to one embodiment.

FIG. 5 to FIG. 7 show techniques to cause a memory sub-system to transfer data between a storage space of the memory sub-system and a memory space of the memory sub-system according to some embodiments.

FIG. 8 shows error correction encoding and decoding for data transfers between a storage space and a memory space of the memory sub-system according to one embodiment.

FIG. 9 to FIG. 13 show configurations of a memory sub-system having one or more connections to a host system for storage access and memory access according to some embodiments.

FIG. 14 shows communications to load a portion of data stored at a logical block address in a memory sub-system to a host system according to one embodiment.

FIG. 15 shows communications to store data from a host system to a logical block address in a memory sub-system according to one embodiment.

FIG. 16 to FIG. 19 show methods to manage access to a memory space of a memory sub-system and a storage space of the memory sub-system according to some embodiments.

FIG. 20 is a block diagram of an example computer system in which embodiments of the present disclosure can operate.

### DETAILED DESCRIPTION

At least some aspects of the present disclosure are directed to techniques to facilitate efficient access of a storage space of a memory sub-system at a granularity level smaller than the level of an atomic read or write operation in the memory sub-system in retrieving data from memory cells or programming data into the memory cells.

A memory sub-system, such as a solid-state drive, can be configured to read or write data in a storage space according to a logical block addressing (LBA) block size. For example, to execute a read command, a solid-state drive retrieves at least one LBA block of data from a page of memory cells via an atomic read operation, in which the solid-state drive senses the states of the memory cells to determine the data stored in the memory cells and, decodes raw data corresponding to the states using an error correction code technique to recover the data stored in the page. To execute a write command, the solid-state drive encodes the data, having the LBA block size and to be programmed into the memory cells of the page, to generate encoded data, and programs the memory cells in the page in an atomic write operation, in which the solid state drive programs the states of the memory cells to represent the encoded data to represent the data being written into the page. The LBA block size is typically 512 bytes or larger (e.g., 4096 bytes) for improved efficiency of the solid-state drive in executing read and write commands.

However, some applications typically use a small chunk of data stored in an LBA block in a typical computation task. For example, a chunk of 128 bytes of data is typically used at a time for inference computations of an artificial neural network (ANN). It is inefficient to move an entire block of data, according to the LBA block size of 512 bytes or more (e.g., 4096 bytes), from the solid-state drive into the main memory of a processor only for the processor to use a chunk/sub block of 128 bytes of the entire block.

At least some aspects of the present disclosure address the above and other deficiencies and challenges by configuring a memory sub-system to expose at least a portion of its random access memory for access by a host system. The memory space of the exposed random access memory is configured to be separate and independent from the storage space of the memory sub-system. The host system can use storage access commands to instruct the memory sub-system to transfer data, according to the LBA block size and within the memory sub-system, between the random access memory of the memory sub-system and the storage space of the memory sub-system. Separately, the host system can use memory access instructions to load data from and/or store data to the exposed memory space of the memory sub-system at a granularity level that is smaller than the LBA block size. Thus, the host system can have the options to use a combination of memory access request and storage access request to retrieve data from and/or store data to the storage space of the memory sub-system by communicating sub blocks of data between the host system and the memory sub-system.

For example, the random access memory of the memory sub-system can be attached to the host system during a boot time as a memory device such that the host system can load data from and store data to the random access memory using a memory access protocol (e.g., a protocol of compute express link (CXL) or component interconnect express (PCIe)) and/or via executions of load instructions and store instructions. Further, the host system can send a read command to the memory sub-system to read a block of data according to the LBA block size of the memory sub-system into the random access memory of the memory sub-system using a storage access protocol (e.g., non-volatile memory express (NVMe)). During the execution of the read command, the data of the LBA block size is internally retrieved from the storage space of the memory sub-system and copied to the random access memory of the memory sub-system. As a result of the execution of the read command in the memory sub-system, the memory sub-system makes sub blocks of the data accessible to the host system in the random access memory of the memory sub-system without sending the data across the connection between the memory sub-system and the host system.

Once the data is in the random access memory of the memory sub-system, the host system has choices as to when and whether to load any portions of the data from the random access memory of the memory sub-system to the host system for processing. For example, the host system can use the memory access protocol (e.g., in accordance with CXL or PCIe) to load a selected portion of the data from the random access memory by addressing the selected portion using one or more memory addresses in the random access memory of the memory sub-system. Since the memory access protocol (e.g., CXL protocol) allows accessing the random access memory of the memory sub-system at the granularity level of byte (e.g., one byte, 8 bytes, 16 bytes, 32 bytes, or a cache line of 128 bytes), the host system can load a portion (e.g., sub block) of the block from the random access memory of the memory sub-system when the portion is about to be used in computation. Thus, the host system does not have to allocate a space in its main memory sufficient to hold the entire block of data according to the LBA block size; and the efficiency of the usage of the main memory of the host system is improved. In some cases, at least a portion of the entire block of data is not used in computations performed in the host system in a period of time. Thus, the host system can skip loading such a portion over a connection between the memory sub-system and the host system; and the efficiency of the usage of the communications bandwidth of the connection is improved.

For example, when the host system is to modify a portion of the data stored as a block according to the LBA block size in the storage space of the memory sub-system, the host system can use a read command to retrieve the block of data into the random access memory of the memory sub-system. Then, the host system can use the memory access protocol (e.g., CXL or PCIe) to store the modified portion of the block into the random access memory, without communications of the remaining portion of the block between the host system and memory sub-system. Subsequently, the host system can use a write command to cause the memory sub-system to write the block of data from the random access memory of the memory sub-system into the storage space of the memory sub-system. Thus, the efficiency of the usages of the main memory of the host system and the communications bandwidth of the connection between the memory sub-system and the host system can be improved.

For example, consider a scenario of using such a memory sub-artificial intelligence (AI) inference computations. A trained artificial neural network (ANN) model can be used to make inference/predictions. Inference/prediction computations can have many tasks running in parallel on different graphical processing unit (GPU) cores. There can be over a hundred GPUs in a cluster, where each GPU can have hundreds or more of cores. Potentially, there can be over 10,000 or so inference processes running in parallel, each running in a separate GPU core to access a different part of the memory sub-system (e.g., solid-state drive (SSD)) storing the AI/ANN model. Each part being accessed can be smaller than the LBA block size. The memory sub-system can be configured to support a large number of parallel commands coming from the inference processes running in the GPU cores. After an LBA block is read from an LBA address to the random access memory of the memory sub-system, an inference/prediction process/thread running in a GPU core can load the small portion that is to be used in its computation into the high bandwidth memory (HBM) of the GPU core, eliminating the need to allocate a sufficient space in the HBM to store the entire LBA block and eliminating the transfer of unused portions of the LBA block from the memory sub-system to the HBM of the GPU core. Instead of allocating memory from HBM at the granularity of an LBA block size (e.g., 4 KB) to hold data read from the memory sub-system, the inference/prediction process/thread can allocate memory from HBM at the granularity level of a cache line (e.g., 128 bytes). HBM is an expensive, high-performance resource in GPUs. Optionally, the inference/prediction process/thread can modify, in the HBM, the portion of the LBA block that has been loaded into the HBM of the GPU core; and to store the modified LBA block back to the storage space of the memory sub-system, the inference/prediction process/thread can identify the portion of the block in the HBM via a scatter gather list (SGL) to cause the memory sub-system to combine the portion in the HBM and the unmodified portion in the random access memory of the memory sub-system to write the modified LBA block to the storage space. Avoid loading unused portions of data into HBM can improve and optimize the usages of HBM as a key resource; and the performance of the system can be greatly improved.

Such a memory sub-system can have backward compatibility with storage access protocols (e.g., NVMe protocol). When the host system is to use an entire block of data according to the LBA block size, the host system can configure and send a read command to cause the memory sub-system to send the data retrieved from the storage space of the memory sub-system to a memory location identified by the host system. For example, the read command can be configured by the host system to identify a location in the main memory of the host system as the destination of the storage access request; and in response, the memory sub-system can send the retrieved data to the main memory of the host system during the execution of the read command such that it is not necessary for the host system to further use memory access protocols to load data from the memory sub-system.

Optionally, the host system can use the random access memory of the memory sub-system as a buffer to hold data retrieved from the storage space of the memory sub-system for a period of time decided by the host system. During the period of time, the host system can load any portion of the data from the random access memory and/or modify any portion of the data in the random access memory of the memory sub-system. Accessing the random access memory of the memory sub-system using a memory access protocol (e.g., CXL protocol) is much faster than accessing the storage space of the memory sub-system using a storage access protocol (e.g., NVMe protocol). Thus, such a memory sub-system provides the host system with the option to predicatively send read commands to the memory sub-system to retrieve data from the storage space for buffering in the random access memory of the memory sub-system to reduce latency in accessing the data for the processing of the data.

Optionally, the memory sub-system can be configured to provide a host system with access to both a memory space of the random access memory of the memory sub-system and the storage space of non-volatile memory cells of the memory sub-system via a same connection. The memory space and the storage space are separately addressable by the host system using a memory access protocol and a storage access protocol over the same connection.

For example, the memory sub-system can be configured with a random access memory addressable by a host system via a memory access protocol (e.g., compute express link (CXL) over a peripheral component interconnect express (PCIe) connection). The random access memory can be implemented using a fast memory that can be volatile (e.g., dynamic random access memory (DRAM)). The memory sub-system can offer the random access memory as a memory device attachable to the host system during the boot time; and the host system can be configured to add the memory space of the memory device offered by the memory sub-system into its memory map. Thus, the host system can access the random access memory of the memory sub-system in a same way as accessing other memory devices attached to the host system using the memory access protocol (e.g., CXL).

The memory sub-system can be further configured with a storage medium (e.g., NAND memory) addressable by a host system via a storage access protocol (e.g., non-volatile memory express (NVMe) over the peripheral component interconnect express (PCIe) connection). The storage medium is non-volatile and slower than the random access memory.

The memory sub-system allows a host system to access the memory space and the storage space independently without imposing a predefined relation between the memory space and the storage space. The memory space can be substantially smaller than the storage space. The memory sub-system can provide the host system with complete control over how the memory space is used by the host system. Optionally, the host system can use the memory space in accessing the storage space (e.g., to reduce communications over a computer bus between the memory sub-system and the host system).

For example, the memory sub-system can receive storage access commands configured to address the storage medium of the memory sub-system. The commands can be provided to the memory sub-system via submission queues configured in cyclic buffers accessible to both the host system and the memory sub-system. For example, the cyclic buffers can be configured in a portion of the main memory of the host system, or in the random access memory of the memory sub-system.

The storage medium of the memory sub-system is configured to be addressed at the granularity level of the LBA block size that is coarser than the granularity level of addressing the random access memory of the memory sub-system. For example, the storage medium can be accessed at a block level of 4096 bytes or 512 bytes per block. The random access memory can be access at a byte level (e.g., one byte, 16 bytes) or a cache line level (e.g., 128 bytes).

A storage access command (e.g., a read command or a write command) can be configured to identify a memory address for storing or retrieving data addressed by the storage access command. For example, a read command can specify a memory address as the destination to store the data to be read from the storage medium at a logical block addressing (LBA) address specified by the read command. For example, a write command can identify a memory address as the source where data can be retrieved for writing to the storage medium at a logical block addressing (LBA) address specified by the write command.

When the memory sub-system is configured to expose at least a portion of its random access memory for accessing by the host system, the host system can optionally configure the memory address, identified in the storage access command, in the random access memory of the memory sub-system. When the storage access command specifies a memory address that is in the random access memory of the memory sub-system, the execution of the storage access command does not involve communicating data over the connection between the host system and the memory sub-system.

The host system can use the random access memory of the memory sub-system as a staging ground for the data to be read from or written into the storage space of the memory sub-system. For example, the host system can assemble a block of data in the random access memory for writing into the storage medium of the memory sub-system, or prefetch a block of data from the storage medium into the random access memory for selective accessing a portion (e.g., a sub block) of the block. The availability of the staging ground within the memory sub-system can be used to reduce data traffic in the communication connection (e.g., the PCIe connection) between the memory sub-system and the host system in some applications, such as applications involving the computations of an artificial neural network.

The host system can be configured to access sub blocks of an LBA block in the storage space of the memory sub-system using a combination of storage access commands and memory access instructions. For example, the host system can be configured to allocate a block of random access memory from the memory sub-system and store data one chunk at a time into the allocated block of random access memory. When the block of data is ready in the random access memory for being stored into the storage space of the memory sub-system, the host system can enter a write command in a submission queue for the memory sub-system, where the write command is configured to cause the memory sub-system to write the data from the random access memory to the storage space of the memory sub-system.

Optionally, the host system can configure a storage access command (e.g., a read command or a write command) to specify a block of memory addresses having a capacity size that is different (e.g., smaller than) from the LBA block size. The memory sub-system can be configured to determine the size mismatch between the block of memory address identified by the storage access command and the data block being addressed via an LBA address specified in the storage access command. In response to a detected size mismatch, the memory sub-system can perform filtering operations and/or read operations accordingly.

For example, when the capacity size of the block of memory addresses identified in the storage access command is smaller than the LBA size and the storage access command includes an opcode for a write operation, the memory sub-system can perform a read-modify-write operation at the LBA address identified in the storage access command. For example, the memory sub-system can perform a read operation to retrieve the data block currently stored at the LBA address, modify the retrieved data block using the data currently at the block of memory addresses, and write the modified data block to the LBA address. Alternatively, the memory sub-system can use the data currently at the block of memory addresses to modify a block of data having a predetermined value (e.g., zero) to generate the modified data block for writing to the LBA address.

For example, when the capacity size of the block of memory addresses identified in the storage access command is smaller than the LBA size and the storage access command includes an opcode for a read operation, the memory sub-system can perform a filtering operation on the data read from the LBA address identified in the storage access command to generate the data being stored into the block of memory addresses. For example, the memory sub-system can remove the beginning portion and/or the ending portion of the data block read from the LBA address to generate the data having a size matching the capacity size of the block of memory addresses; the memory sub-system can store the generated data into the block of memory addresses to complete the execution of the storage access command.

Optionally, when the host system is to write only a portion of an LBA block into the storage space of the memory sub-system, the host system can allocate a block of the random access memory of the memory sub-system according to the LBA block size and send a read command to retrieve the data of the LBA block from the storage space into the allocated block of random access memory of the memory sub-system. Optionally, the read command can also function as a request to allocate the block of the random access memory of the memory sub-system. The host system can then store data to the portion of the block via memory access operations to modify the data of the LBA block in the random access memory. Subsequently, the host system can send a write command to cause the memory sub-system to write the modified block of data from the random access memory of the memory sub-system to the storage space of the memory sub-system. Optionally, the write command can function as a request to free the block of the random access memory allocated as the staging ground for the modified block of data.

To retrieve a sub block from the storage space of the memory sub-system, the host system can configure a read command to cause the memory sub-system to read a block (e.g., 4096 bytes or 512 bytes) of data into a block of the random access memory of the memory sub-system as a staging ground. Subsequently, the host system can execute one or more load instructions to fetch one or more portions of the block from the staging ground into its memory, such as a high bandwidth memory (HBM) in a graphics processing unit (GPU).

To write a block of data having the LBA block size to the storage space of the memory sub-system, the host system can execute store instructions to build up the block of data, one sub block a time, in the random access memory in the memory sub-system as a staging ground. After the completion of building the block of data, the host system can configure a write command to cause the memory sub-system to write the block of data from the staging ground in the memory sub-system into the storage space of the memory sub-system.

To write a sub block to the storage space of the memory sub-system, the host system can configure a read command to cause the memory sub-system to read a block (e.g., 4096 bytes or 512 bytes) of data, according to the LBA block size, into the random access memory of the memory sub-system as a staging ground. Then, the host system can execute one or more store instructions to modify one or more portions of the block in the staging ground. Then, the host system can configure a write command to cause the memory sub-system to write the modified block into the storage space of the memory sub-system.

Optionally, the memory sub-system can be configured to have multiple, separate connections to the host system such that the host system and the memory sub-system can use the connections in parallel for concurrent storage access communications and memory access communications.

For example, a first interface of the memory sub-system can provide a first connection between a host system and the memory sub-system to allow the host system to access the memory space of the memory sub-system; and a second interface of the memory sub-system can provide a second connection between the host system and the memory sub-system to allow the memory sub-system to access a memory of the host system. For example, while the first connection is being used by the host system to retrieve or modify a sub block of data in the memory space of the memory sub-system, the second connection can be used concurrently by the memory sub-system to retrieve a command from a submission queue configured in the memory of the host system, or write a completion record in a completion queue configured in the memory of the host system, or to retrieve data from (or store data to) the memory of the host system during execution of a write (or read) command that specifies a memory address in the memory of the host system as the data source (or destination).

Optionally, a random access memory external to the memory sub-system and the host processor can be used as the staging ground. For example, the memory sub-system can be configured with a first interface to access a random access memory outside of the memory sub-system. The random access memory can be provided by a memory device having random access memory cells and connected to the first interface of the memory sub-system (e.g., via a CXL connection and/or a CXL fabric). The memory sub-system can access the random access memory via a memory access protocol (e.g., compute express link (CXL)). The host processor can be configured to access the random access memory of the memory device (e.g., via another CXL connection and/or the CXL fabric) without going through any interface of the memory sub-system. The memory sub-system is configured with a storage medium (e.g., NAND memory) addressable by the host system via a storage access protocol (e.g., non-volatile memory express (NVMe)). To provide the host processor with access to the storage medium, the memory sub-system is configured with a second interface for a separate connection to the host processor.

For example, the memory sub-system can be configured to obtain, through the second interface, storage access commands from submission queues configured in cyclic buffers accessible to both the host system and the memory sub-system. For example, the cyclic buffers can be configured in a portion of the main memory of the host system, or in the random access memory of the memory device located outside of the memory sub-system, or in the memory space of the memory sub-system. The storage medium of the memory sub-system is configured to be addressed at a granularity level that is coarser than the random access memory. For example, the storage medium can be addressed at the LBA block size of 4096 bytes or 512 bytes. The random access memory is configured to be access at a byte level (e.g., one byte, 8 bytes, 16 bytes, 32 bytes), or at a cache line level (e.g., 128 bytes).

A storage access command (e.g., a read or write command) can identify a memory address for storing data to, or retrieving data from, a memory address identified by the storage access command. For example, a read command can specify the memory address as the destination to store the data to be read from the storage medium at a logical block addressing (LBA) address specified by the read command. For example, a write command can identify the memory address as the source where data can be retrieved for writing to the storage medium at a logical block addressing (LBA) address specified by the write command. The memory address identified in the storage access command can be optionally in the random access memory of the memory device located outside of the memory sub-system. While the memory sub-system is executing such a storage access command, the memory sub-system can use the first interface to store data to (or load data from) the memory device outside of the memory sub-system and concurrently using the second interface to retrieve another storage access command from a submission queue (or store a completion record for another storage access command to a completion queue) in the main memory (or another memory device located outside of the memory sub-system).

For example, a CXL or PCIe fabric can be used to connect a plurality of memory devices, the memory sub-system, and a host processor. The host processor can use the random access memory of the memory sub-system and/or the random access memory of the memory devices as a staging ground to assemble a block of data to be written into the storage medium of the memory sub-system, or to prefetch a block of data for selective accessing a portion of the block. Optionally, the host processor can also configure a submission queue and/or a completion queue for the memory sub-system in the random access memory of the memory sub-system and/or the random access memory of the memory devices. Such usages of the random access memory on a CXL or PCIe fabric can reduce the traffic to and/or from the main memory of the host processor, and/or improve the usage of the bandwidth of the main memory of the host processor (e.g., in applications involving an artificial neural network).

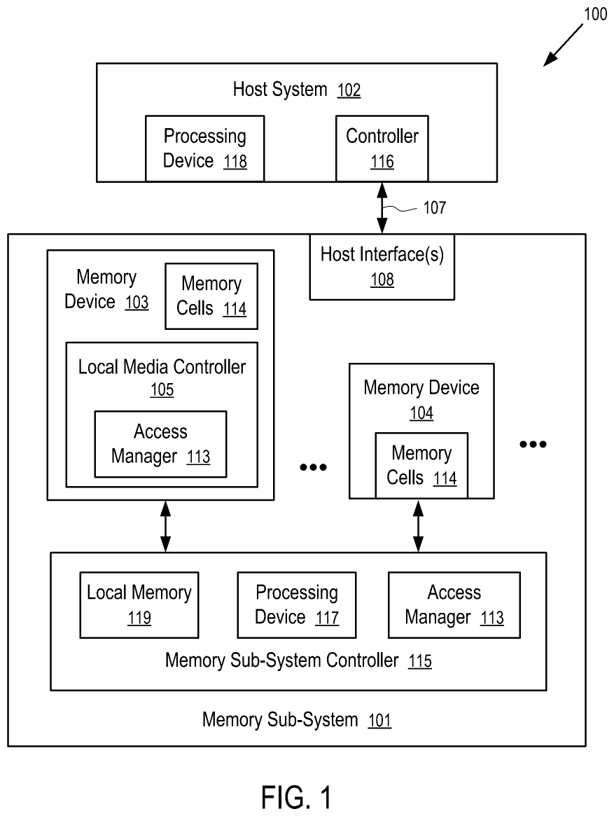

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include an access manager 113 configured to perform operations related to accessing a storage space of the memory sub-system 101. In some embodiments, the controller 115 in the memory sub-system 101 includes at least a portion of the access manager 113. In other embodiments, or in combination, the controller 116 and/or the processing device 118 in the host system 102 includes at least a portion of the access manager 113. For example, the controller 115, the controller 116, and/or the processing device 118 can include logic circuitry implementing the access manager 113. For example, the controller 115, or the processing device 118 (processor) of the host system 102, can be configured to execute instructions stored in memory for performing the operations of the access manager 113 described herein. In some embodiments, the access manager 113 is implemented in an integrated circuit chip disposed in the memory sub-system 101. In other embodiments, the access manager 113 can be part of firmware of the memory sub-system 101, an operating system of the host system 102, a device driver, or an application, or any combination therein.

For example, the access manager 113 implemented in the controller 115 and/or 105 of the memory sub-system 101 can be configured to expose a portion of the random access memory (e.g., local memory 119 and/or a subset of the memory devices 103 to 104) as a memory device attachable to the host system 102 during a boot time of the computing system 100. The memory space of the exposed portion of the random access memory can be added to the memory map of the host system 102 such that the memory controller 116 can access the memory space according to a standard for memory access (e.g., compute express link (CXL)) in response to execution of memory access instructions (e.g., store instructions, load instructions) in the processing device 118. The access manager 113 implemented in the computing system 100 can be configured to facilitate the access of the storage space provided by the non-volatile memory cells (e.g., 114 in one or more of the memory devices 103 to 104) using the memory space as a staging ground, as further discussed below. Alternatively, a memory device configured outside of the memory sub-system 101 can accessible via the host interface(s) 108 of the memory sub-system 101 can be used as the staging ground and/or a buffer memory for the storage space.

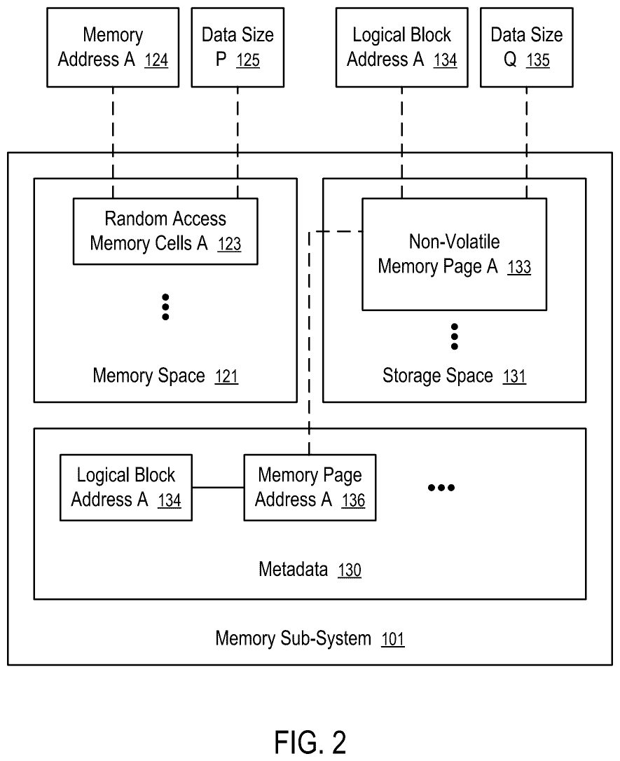

FIG. 2 shows a memory sub-system having a storage space and a memory space that are both accessible to a host system according to one embodiment. For example, the memory sub-system 101 in the computing system 100 of FIG. 1 can be implemented in a way as illustrated in FIG. 2.

In FIG. 2, the memory sub-system 101 includes a memory space 121 and a storage space 131 that is separate from the memory space 121. There is no overlapping area between the memory space 121 and the storage space 131.

For example, the memory space 121 can be implemented using memory cells 114 provided in a first subset of memory devices 103, . . . , 104 configured within the memory sub-system 101; and the storage space 131 can be implemented using memory cells in a second subset of the memory devices 103, . . . , 104. For example, there is no overlapping between the first subset and the second subset in some implementations.

For example, the first subset of the memory devices 103, . . . , 104 can have random access memory cells 123 operable and/or accessible at granularity of a smaller data size 125 (e.g., one byte, 16 bytes, or a cache line of 128 bytes). The second subset of the memory devices 103, . . . , 104 can have memory cells 114 configured as memory pages (e.g., 133) operable and/or accessible at granularity of a larger data size 135 (e.g., 512 bytes, or 1024 bytes, or 4096 bytes). For example, the capacity of the memory space 121 can be a fraction of the capacity of the storage space 131.

For example, the random access memory cells (e.g., 123) used to implement the memory space 121 can be volatile and faster in access than the memory pages (e.g., 133) used to implement the storage space 131. For example, the random access memory cells (e.g., 123) can be dynamic random access memory (DRAM), such as synchronous DRAM (SDRAM), or static random access memory (SRAM), etc.

For example, the memory cells 114 used to implement the memory pages (e.g., 133) in the storage space 131 can be non-volatile and slower in access than the random access memory cells (e.g., 123). For example, the memory pages (e.g., 133) can be implemented using flash memory (e.g., NAND memory, NOR memory).

A smallest portion of the memory space 121 that can be addressed by a host system (e.g., 102) for access using a load or store instruction and a memory address (e.g., 124) can be configured to have the data size 125. A memory address (e.g., 124) represents a unit of data storage capacity of the predetermined data size 125 in the memory space 121. The memory space 121 can be physically subdivided into units of the same predetermined data size 125 for addressing using memory addresses (e.g., 124). When a memory address 124 is provided for loading data from or for storing data into the memory space 121, the memory sub-system 101 can determine the unit of random access memory cells (e.g., 123) identified by the memory address (e.g., 124) without using a look up table. The memory address 124 can be fixedly associated with a unit of random access memory cells 123 in the memory sub-system 101. An operation to store data to the memory address 124 does not result in a change in the unit of random access memory cells 123 represented by the memory address 124. A host system (e.g., 102) can use a memory access protocol (e.g., CXL) to load data from, or store data to, the unit of random access memory cells (e.g., 123) represented by the memory address (e.g., 124) over a connection 107 between the host system (e.g., 102) and the memory sub-system 101. Optionally, the memory access protocol can be cache coherent.

A smallest portion of the storage space 131 that can be addressed by a host system (e.g., 102) for access using a read or write command and a logical block address (e.g., 134) can be configured to have the data size 135. For example, the logical block address (e.g., 134) can be an LBA address as in a standard for storage access protocol (e.g., NVMe). The logical block address (e.g., 134) represents a logical unit of data storage capacity of the predetermined data size 135 in the storage space 131. The storage space 131 is logically subdivided into units of the same predetermined data size 135 for addressing using logical block addresses (e.g., 134). The memory sub-system 101 stores metadata 130 containing a look up table configured to map logical block addresses (e.g., 134) to memory page addresses (e.g., 136). When a logical block address 134 is provided for reading data from or writing data into the storage space 131, the memory sub-system 101 can use the metadata 130 to determine the physical memory page address 136 to perform the read or write operation. To write data to the logical block address 134, the memory sub-system 101 can allocate a fresh memory page that is ready to be programmed to store data (e.g., a memory page of memory cells that are in an erased state), update the metadata 130 to map the logical block address 134 to the address of the allocated memory page, and programmed the memory cells in the allocated memory page to store the data. If the logical block address 134 is previously associated with a memory page address 136, the memory sub-system 101 can update the metadata 130 such that the logical block address 134 is no longer associated with the memory page address 136; and the memory sub-system 101 can further store data indicating that the memory cells at the memory page address 136 can be erased. To read data from the logical block address 134, the memory sub-system 101 uses the metadata 130 to determine the memory page address 136 currently associated with the logical block address 134 and perform operations to sense the states of memory cells in the memory page 133 identified by the memory page address 136 to determine the data represented by the states of the memory cells. Since the mapping between logical block addresses (e.g., 134) and memory page addresses (e.g., 136), as defined in the metadata 130, can change over time (e.g., in response to deletion data from logical block addresses and overwriting data to logical block addresses), a logical block address (e.g., 134) does not always represent a same physical memory page (e.g., 133) at a memory page address (e.g., 136) in the memory sub-system 101. An operation to write data to the logical block address 134 results in a change in the page 133 of non-volatile memory cells (e.g., 114) represented by the logical block address 134.

A host system (e.g., 102 as in FIG. 1) can use a storage access protocol (e.g., NVMe) to read data from, or write data to, the unit of non-volatile memory cells (e.g., in a memory page 133) currently represented by a logical block address 134 according to the metadata 130 stored in the memory sub-system 101. For example, the host system 102 can enter a read or write command in a cyclic buffer according to an NVMe protocol; and the memory sub-system 101 can retrieve the read or write command from the cyclic buffer for execution. The read command can identify a memory address as the destination for storing the data to be read from a logical block address (e.g., 134) specified in the read command; and the write command can identify a memory address as the source for retrieving of the data to be written to a logical block address (e.g., 134) specified in the write command. The memory sub-system 101 is configured to access the memory address identified in the read or write command during the execution of the read or write command.

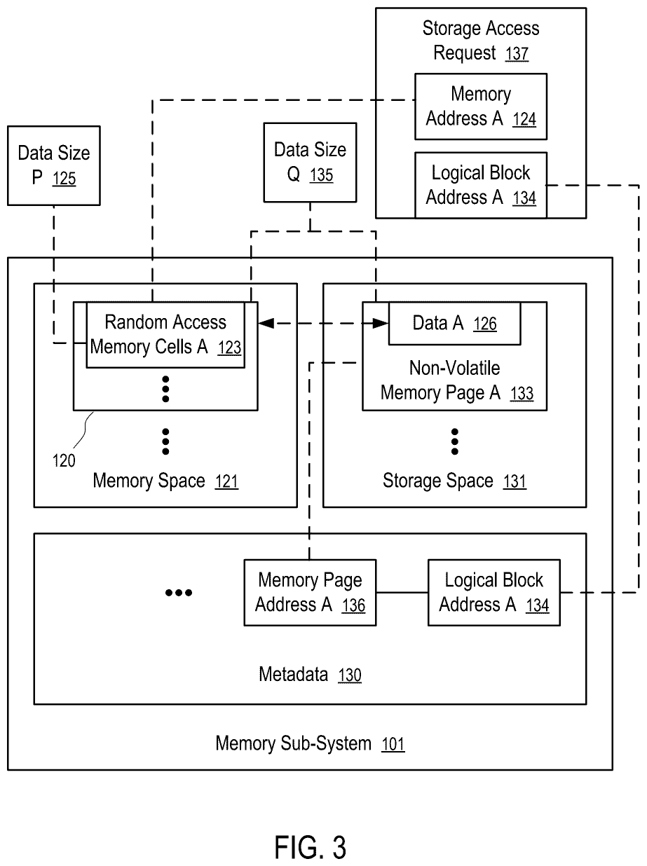

The memory sub-system 101 allows the host system to identify, in a read or write command, a memory address (e.g., 124) that represents a location in the memory space 121 within the memory sub-system 101. When such a read command having a memory address 124 is executed in the memory sub-system 101, the data retrieved from the logical block address 134 as identified in the read command is loaded into the memory space 121 within the memory sub-system 101; and none of the data retrieved from the logical block address 134 is communicated to outside of the memory sub-system 101 during the execution of the read command, as further discussed below in connection with FIG. 3. As a result, the execution of such a read command is reduced to an internal operation within the memory sub-system 101.

Similarly, when such a write command having a memory address 124 is executed in the memory sub-system 101, the data to be written into the storage space 131 at the logical block address 134 is retrieved from the memory space 121 within the memory sub-system 101; and none of the data being written to the logical block address 134 is communicated from outside of the memory sub-system 101 during the execution of the write command, as further discussed below in connection with FIG. 3. As a result, the execution of such a write command is reduced to an internal operation within the memory sub-system 101.

FIG. 3 shows a technique of using a storage access request to transfer data between a storage space and a memory space of a memory sub-system according to one embodiment, such as the memory sub-system 101 of FIG. 2.

In FIG. 3, a storage access request 137 is sent to the memory sub-system 101 to read data 126, or write data 126 to, a logical block address 134 in the storage space 131 of the memory sub-system 101. The storage access request 137 is configured to identify not only the logical block address 134 in the storage space 131 of the memory sub-system 101, but also a memory address 124 in the memory space 121 in the memory sub-system 101.

For example, the storage access request 137 can be a read command or a write command configured in accordance with a standard of non-volatile memory express (NVMe). When the storage access request 137 includes an opcode for a read operation, the storage access request 137 represents a read command; and when the storage access request 137 includes an opcode for a write operation, the storage access request 137 represents a write command.

When the storage access request 137 is a read command, the execution of the read command in the memory sub-system 101 causes the memory sub-system 101 to determine, using the metadata 130, the memory page address 136 that is associated with the logical block address 134 in the metadata 130. Using the memory page address 136, the memory sub-system 101 performs the read operation on the memory page 133 to retrieve the data 126 programmed into the memory cells (e.g., 114) in the memory page 133. For example, the read operation can include applying read voltages to the memory cells (e.g., 114) in the memory page 133 to determine the states of the memory cells (e.g., 114). For example, when a read voltage is applied to a memory cell 114, the memory cell 114 can have a state of allowing more than a threshold amount of current to go through the memory cell 114, or a state of allowing a negligible amount of current to go through the memory cell 114. Optionally, a plurality of different read voltages can be applied to determine the states of the memory cell 114 at the respective read voltages. The data having been programmed into the memory cell 114 can be determined based on the states of the memory cells 114 at the read voltages. In some implementations, a single memory cell can be programmed to store data having more than one bit.

After determining the data 126 stored in the memory page 133, the memory sub-system 101 can store the data into a block 120 of random access memory cells (e.g., 123) in the memory space 121. Optionally, the memory sub-system 101 can update the metadata 130 to indicate that the data of the logical block address 134 now resides (or has a cached/buffered version) in the memory space 121 at the memory address 124. The block 120 of memory cells has a plurality of units of memory cells (e.g., 123), where each unit of memory cells (e.g., 123) is represented by one memory address (e.g., 124) in the memory space 121. Thus, the data at one logical block address 134 in the storage space 131 is read internally within the memory sub-system 101 into the memory space 121 at a plurality of memory addresses (e.g., 124).

The block 120 of random access memory cells used to store the data 126 retrieved from the logical block address 134 can be identified based on the memory address 124 specified in the read command and the data size 135 of the block of data 126 stored in the memory page 133. For example, the block 120 of random access memory cells (e.g., 123) can start with the unit of memory cells 123 at the memory address 124 specified in the storage access request 137. The unit of the memory cells 123 can hold the beginning portion of the data 126 according to the data size 125. Multiple contiguous units of memory cells (e.g., 123) having consecutive memory addresses (e.g., 124) in the memory space 121 can be used to store respective portions of the data 126 retrieved from the logical block address 134.

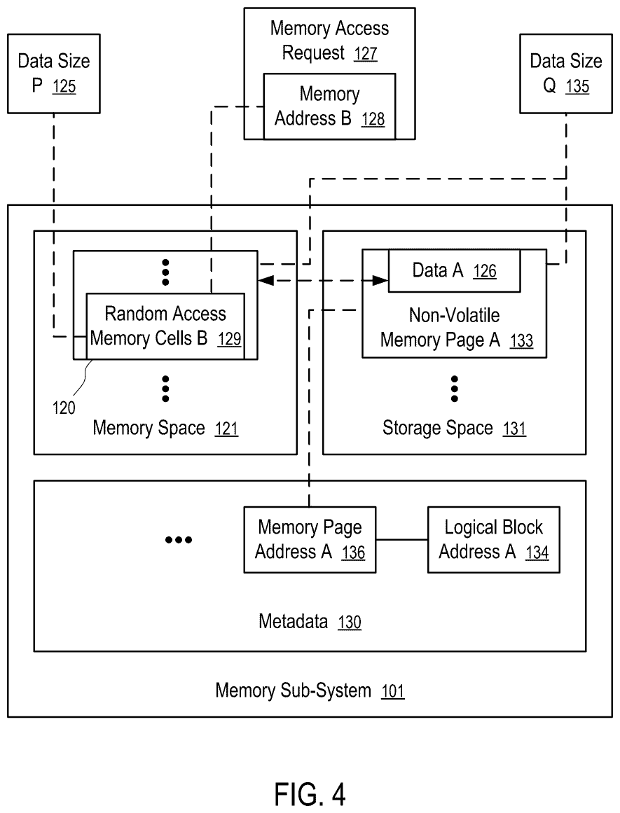

Once the data 126 is in the block 120 of random access memory cells (e.g., 123) in the memory space 121, the host system 102 can use a memory access protocol (e.g., compute express link (CXL) or peripheral component interconnect express (PCIe)) to access any portion(s) of the data 126 using one or more of the memory addresses (e.g., 124) in the block 120, without communicating the remaining portion(s) of the block 120 across the connection 107 between the memory sub-system 101 and the host system 102. For example, the host system 102 can use the block 120 of the memory space 121 as a staging ground to buffer the data 126 from the storage space 131 and access the memory space 121 for a selected portion of the data 126 at a time when the selected portion is about to be used in computations. Since the latency of loading data from the memory space 121 is significantly lower than the latency of reading data (e.g., 126) from the storage space 131, the host system 102 can predicatively retrieve data from the storage space 131 into the memory space 121 using the storage access request 137 and then load one or more portions of the data 126 from the memory space 121 at the time when the portions are need for computation in the host system 102 (e.g., as in FIG. 4)

Optionally, the host system 102 can use store instructions to store data to one or more portions of the block 120 of random access memory cells (e.g., 123) and thus modify the block of data 126 retrieved from the storage space 131 (e.g., as in FIG. 4). Subsequently, the host system 102 can use a write command to write the modified block of data to the storage space 131.

When the storage access request 137 is a write command, the execution of the write command in the memory sub-system 101 causes the memory sub-system 101 to program the data 126 in the block 120 of the memory space into a memory page 133 in the storage space 131. For example, if the logical block address 134 is associated with a memory page address 136 prior to the execution of the write command, the memory sub-system 101 can store data to indicate that the memory page 133 at the memory page address 136 can be erased. To execute the write command, the memory sub-system 101 allocates a fresh memory page that is ready for being programmed to store data (e.g., a memory page having memory cells in a state of being erased) and update the metadata 130 to associate the logical block address 134 with the memory page address of the allocated fresh memory page. The memory sub-system 101 can perform the write operation on the allocated fresh memory page such that during a read operation, the states of the memory cells in the memory page as programmed can be sensed to provide the same data 126 as being written via the write operation.

FIG. 4 shows a technique of using a memory access request for data transferred between a storage space and a memory space of a memory sub-system according to one embodiment.

For example, after a storage access request 137 (e.g., a read command) is executed in the memory sub-system 101 as in FIG. 3, the data 126 in a logical block address 134 is copied to a block 120 of random access memory cells (e.g., 123, 129) identified via a memory address 124 specified in the storage access request 137. The block 120 of random access memory cells contain a plurality of units of memory cells. Each unit of memory cells (e.g., 123 or 129) has a separate memory address (e.g., 124 or 128). A host system (e.g., 102 as in FIG. 1) can use one of the memory addresses (e.g., 128) in the block 120 to access a respective portion of the data 126 stored in one of the units of memory cells (e.g., 129).

For example, a processing device 118 in the host system 102 can execute a load instruction to cause a memory controller 116 in the host system 102 to generate a memory access request 127 containing a memory address 128 to load data from the block 120 of memory cells 129 in the memory space 121 to the host system 102. In response to the memory access request 127 identifying the memory address 128, the memory sub-system 101 can provide data from a respective unit of memory cells 129 represented by the memory address 128 over the connection 107 to the host system 102.

For example, the memory access request 127 can be in accordance with a standard for compute express link (CXL) or peripheral component interconnect express (PCIe) over a PCIe connection 107 between the host system 102 and the memory sub-system 101.

In general, the memory access request 127 can specify any of the memory addresses (e.g., 124, 128) in the block 120 of memory cells to access a corresponding portion of the data 126 that is stored in a block of storage space 131 represented by a single logical block address 134. Thus, the combination of storage access request 137 and the memory access request 127 allows the host system 102 to load a sub block of the block of data 126, where the size of the sub block corresponds to the data size 125 for memory access.

Optionally, the processing device 118 in the host system 102 can execute a store instructions to cause the memory controller 116 to generate a memory access request 127 to store data to the memory address 128. Thus, a sub block of the block of data 126 as in the unit of memory cells 129 in the block 120 can be modified via the memory access request 127. Optionally, the host system 102 can use the block as a staging ground to build and/or modify the entire content in the block 120 such that a subsequent storage access request (e.g., 137 as in FIG. 3) can be used to write the content from the block 120 to a logical block address (e.g., 134) in the storage space 131 of the memory sub-system 101.

Using the techniques of FIG. 3 and FIG. 4, a host system 102 can efficiently access sub blocks of an LBA block in a storage space 131 configured in the memory sub-system 101 without a need to allocate extra memory in the host system 102 to store the entire LBA block at once and/or without communicating sub blocks of the LBA block that are not going to be used in the computations performed in the host system 102.

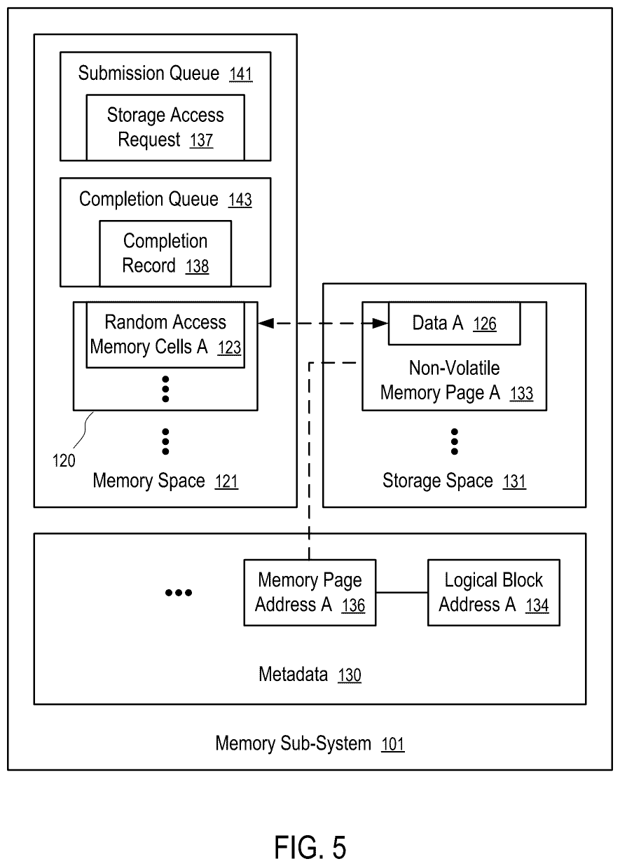

FIG. 5 to FIG. 7 show techniques to cause a memory sub-system to transfer data between a storage space of the memory sub-system and a memory space of the memory sub-system according to some embodiments.

In FIG. 5, a pair of a submission queue 141 and a completion queue 143 are configured in the memory space 121 of the memory sub-system 101 during a boot time of the computing system 100 containing the host system 102 and the memory sub-system 101.

For example, the submission queue 141 and the completion queue 143 can be configured as cyclic buffers according to an NVMe standard. The host system 102 can use a memory access protocol to store a storage access request 137 into the submission queue 141. The storage access request 137 can specify a memory address (e.g., 124) and a logical block address (e.g., 134) as in FIG. 3 for execution by the memory sub-system 101. The memory sub-system 101 can retrieve the storage access request 137 for execution (e.g., as in FIG. 3). Upon completion of the execution of the storage access request 137 (e.g., a read command or a write command as discussed in connection with FIG. 3), the memory sub-system 101 can generate a completion record 138 in the completion queue 143. The completion record 138 can identify the completion status of the storage access request 137. The host system 102 can retrieve the completion record 138 from the completion queue 143 using the memory access protocol.

For example, when the completion record 138 indicates that the read operation of the storage access request 137 is complete, the host system 102 knows that the data 126 is now available in the block 120 of memory cells at a location starting with the memory address 124 specified in the storage access request 137. Thus, a load instruction can be executed subsequently to load a sub block of the data 126 from a memory address (e.g., 128) in the memory space 121.

For example, when the completion record 138 indicates that the write operation of the storage access request 137 is complete, the host system 102 knows that the data 126 is now stored in the logical block address 134 specified in the storage access request 137. Thus, the host system 102 can reuse the block 120 of random access memory cells for other operations, such as building up another block of data, or load data from another logical block address in the storage space 131 into the block 120 in the memory space 121.

When the submission queue 141 and the completion queue 143 are both configured in the memory sub-system 101 (e.g., as in FIG. 5), it is not necessary to configure the memory sub-system 101 with capabilities to access random access memory outside of the memory sub-system 101.

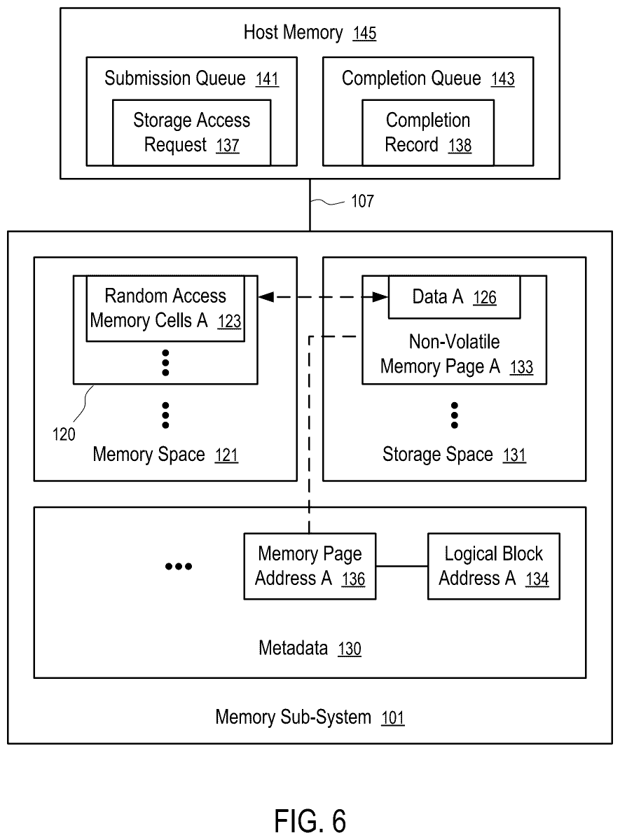

In FIG. 6, a pair of a submission queue 141 and a completion queue 143 are configured in the host memory 145 outside of the memory sub-system 101 during a boot time of the computing system 100 containing the host system 102 and the memory sub-system 101. For example, the host memory 145 can be the main memory of the host system 102 and/or the processing device 118 of the host system 102, or another random access memory that is added to the memory map of the host system 102 during the boot time of the computing system 100.

The memory sub-system 101 is configured to use a memory access protocol (e.g., in accordance with a standard for compute express link (CXL) or peripheral component interconnect express (PCIe) over a PCIe connection 107 between the host system 102 and the memory sub-system 101) to access the host memory 145. For example, the memory sub-system 101 can include a direct memory access (DMA) engine configured to retrieve data from the host memory 145, such as the storage access request 137 provided by the host system 102 in the submission queue 141 (e.g., to specify a memory address 124 and a logical block address 134 in a way as in FIG. 3). As in FIG. 5, after the completion of the execution of the storage access request 137 in the memory sub-system 101, the memory sub-system 101 can use the memory access protocol to enter a completion record 138 in the completion queue 143.

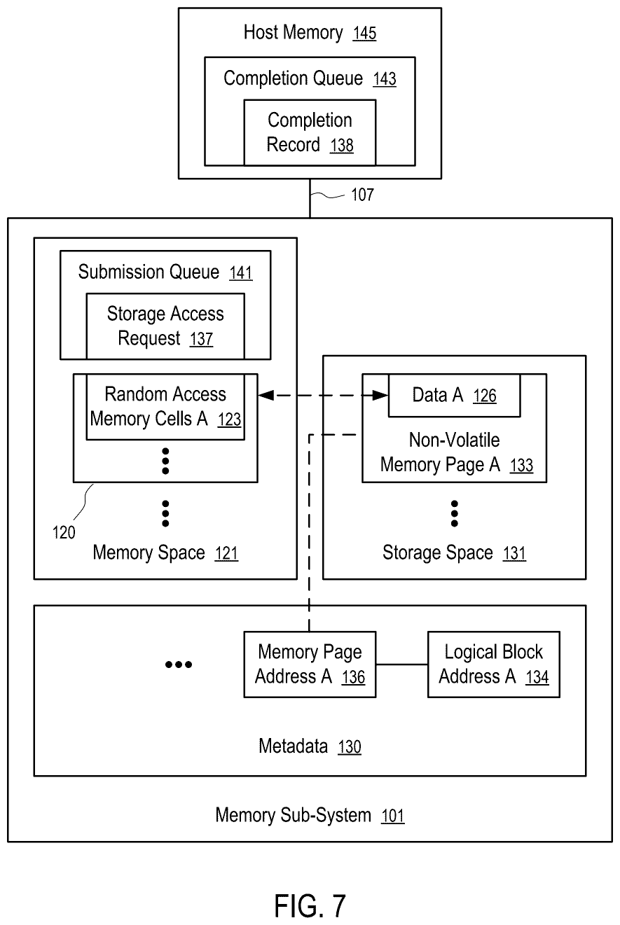

In FIG. 7, the submission queue 141 for storage access requests (e.g., 137) having memory addresses (e.g., 124) in the memory space 121 and/or logical block addresses (e.g., 134) in the storage space 131 is configured in the memory space 121 of the memory sub-system 101 (e.g., as in FIG. 5); and the completion queue 143 is configured in a host memory 145 (e.g., as in FIG. 6). When the memory sub-system 101 detects the writing of a storage access request 137 into the submission queue 141 configured in the memory space 121 of the memory sub-system 101, the memory sub-system 101 can retrieve the request 137 in response, which arrangement can reduce or eliminated the need for the memory sub-system 101 to poll the submission queue 141 regularly to determine whether there is a pending request in the submission queue 141. Similarly, when the host system 102 detects the writing of a completion record 138 in the completion queue 143, the host system 102 can retrieve the record 138 in response, which arrangement can reduce or eliminated the need for the host system 102 to poll the completion queue 143 to determine whether there is a record in the completion queue 143.

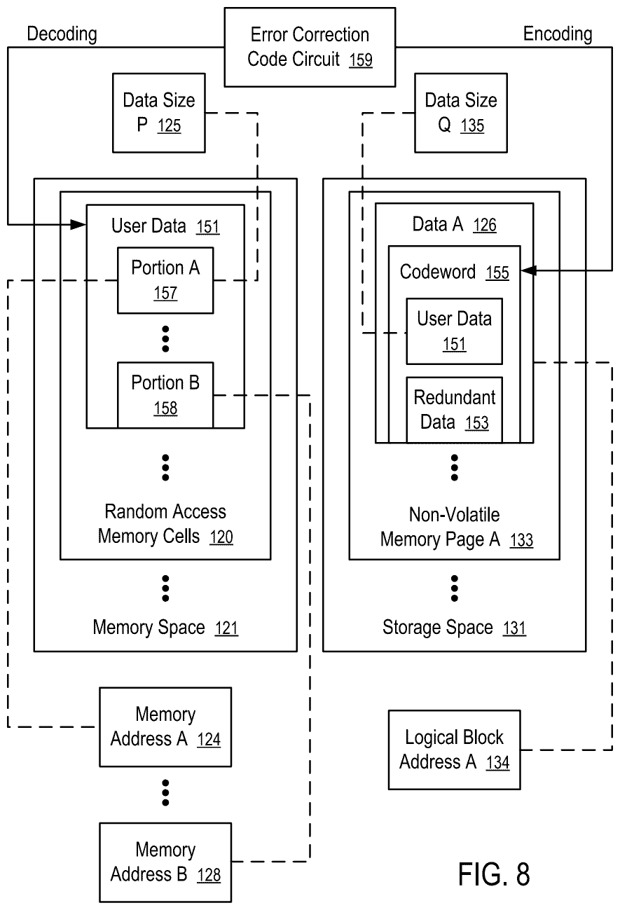

FIG. 8 shows error correction encoding and decoding for data transfers between a storage space and a memory space of the memory sub-system according to one embodiment. For example, the data transfer between a storage space 131 and a memory space 121 as discussed in connection with FIG. 3 to FIG. 7 can include the error correction operations of FIG. 8.

In FIG. 8, a codeword 155 includes user data 151 and redundant data 153. The codeword 155 is stored as the data 126 in a memory page 133 that corresponds to a logical block address 134 according to metadata 130. When the memory sub-system 101 performs a read operation on the memory page 133 to determine the data 126 via sensing the states of memory cells in the memory page 133, the result of the sensing operation can have one or more random bit errors in the portion representing the user data 151 and/or the portion representing the redundant data 153.

An error correction code circuit 159 of the memory sub-system 101 can perform a decoding operation of an error correction code technique (e.g., low-density parity-check (LDPC)) to detect the random bit errors and correct the errors to recover an error-free version of the user data 151 into the block of random access memory cells 120 in the memory space 121.

The decoding operation is configured to operate the retrieved version of the data 126 or codeword 155 retrieved from the memory page 133 as a whole. The memory sub-system 101 and/or the error correction code circuit 159 cannot perform the decoding operation on a portion of the data 126 or codeword 155 to recover an error-free version of only a portion of the user data 151. Thus, to determine an error-free version of any portion of the user data 151 stored in the storage space 131, the entire codeword 155 is sensed and decoded to store the error-free version of the user data 151 in the memory space 121.

The memory cells (e.g., DRAM or SDRAM cells) used to implement the memory space 121 can be more reliable in data storage and retrieval than the memory cells (e.g., NAND or NOR cells) used to implement the storage space 131. Thus, the block 120 of random access memory cells can be configured to store the user data 151 but not the redundant data 153.

Optionally, an error detection and/or correction technique can also be used to detect and/or correct random bit errors in data retrieved from the memory space 121. However, the error detection and/or correction technique can be applied separately for different portions 157, . . . , 158 of the user data 151 stored in the memory space 121, such that the decoding is not dependent on the retrieval of the user data 151 from the block 120 of the random access memory cells as a whole. Instead, the error detection and/or correction technique can be applied to any of the portions 157, . . . , 158 of the user data 151. The portions 157, . . . , 158 of the user data 151 at the memory addresses 124, . . . , 128 respectively can be retrieved separately with error detection and/or correction. Thus, the memory sub-system 101 can retrieve a portion (e.g., 157 or 158) of the user data 151 according to a memory address (e.g., 124 or 128) without retrieving other portions of the user data 151 from the memory space 121.

To write the user data 151 in the memory space 121 to the storage space 131 at the logical block address 134, the error correction code circuit 159 can perform an encoding operation of the error correction code technique (e.g., low-density parity-check (LDPC)) to generate the codeword 155 containing both the user data 151 and the redundant data 153. The memory cells in the memory page 133 are programmed to have states representing the bits of the codewords 155.

The user data 151 can have the data size 135 representative of the capacity to store data for a user at a logical block address 134 in the storage space 131. Each portion (e.g., 157 or 158) of the user data 151 can have the data size 125 representative of the capacity to store data for a user at a memory address (e.g., 124 or 128) in the memory space 121. The data size 135 can be configured as a predetermined multiple of the data size 125. For example, the data size 135 can be 512 bytes, 1024 bytes, 2048 bytes, or 4096 bytes; and the data size 125 can be one byte, 8 bytes, 16 bytes, 32 bytes, 64 bytes, or 128 bytes.

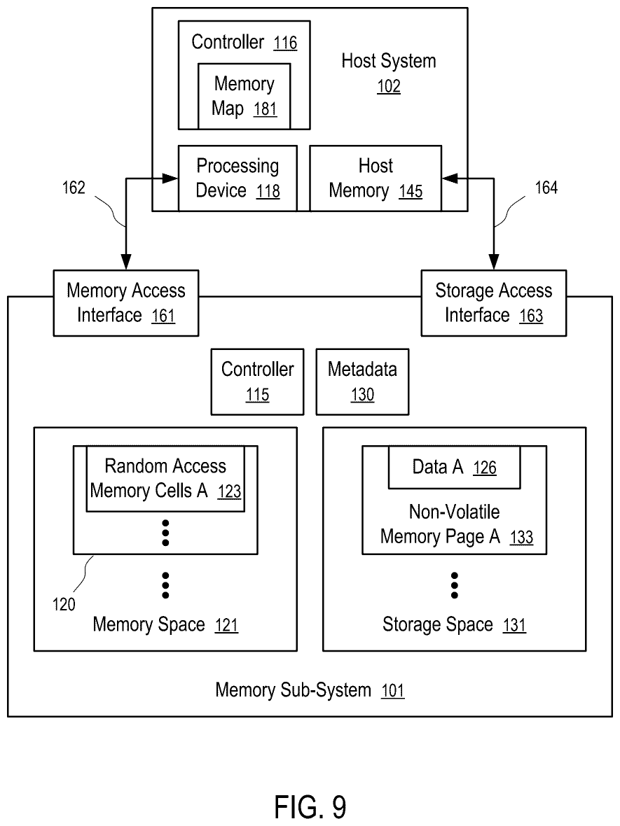

FIG. 9 to FIG. 13 show configurations of a memory sub-system having one or more connections to a host system for storage access and memory access according to some embodiments. For example, the memory sub-system 101 in FIG. 1 to FIG. 8 can be configured with one or more host interfaces according to any of FIG. 9 to FIG. 13.

A typical host system (e.g., 102 in FIG. 1 and FIG. 9) can have a memory controller 116 configured to access memory addresses identified as being accessible in a memory map 181. For example, during a boot time, the computing system 100 can determine memory devices (e.g., the main memory of the processing devices 118, host memory 145, and/or the memory space 121 offered by the memory sub-system 101 as a memory device) that are accessible and/or attached to the processing devices 118 in the computing system 100. The memory map 181 can identify the physical memory addresses of the random access memory in the memory devices detected during the boot time of the computing system 100. The memory controller 116 can map the virtual memory addresses used in the processing devices 118 into the physical memory addresses to access memory when the processing devices 118 execute memory access instructions (e.g., load instructions, store instructions) that identify the virtual memory addresses being accessed.

In FIG. 9, the memory sub-system 101 includes a memory access interface 161 and a storage access interface 163. The memory access interface 161 is connected to the host system 102 via a connection 162; and the storage access interface 163 is connected to the host system 102 via a connection 164 that is separate from the connection 162 to the memory access interface 161.

The memory access interface 161 can be configured to allow a processing device(s) 118 in the host system 102 to access the memory space 121 efficiently with reduced latency. The processing device(s) 118 in the host system 102 can execute load instructions and store instructions to initiate communications over the connection 162 to the memory access interface 161 to load data from and store data to the memory space 121 using a memory access protocol (e.g., in compliance with a standard of compute express link (CXL), peripheral component interconnect express (PCIe), double data rate (DDR)).

The storage access interface 163 can be configured to facilitate communicate storage access communications (e.g., in compliance with standard of non-volatile memory express (NVMe)). For example, the connection 164 can be configured to allow the controller 115 (or a direct memory access (DMA) engine) of the memory sub-system 101 to access, via the connection 164, the host memory 145 to receive storage access requests (e.g., 137) from a submission queue (e.g., 141) configured in the host memory 145 (e.g., as in FIG. 6), to provide completion records (e.g., 138) into a completion queue 143 configured in the host memory 145 (e.g., as in FIG. 6 and FIG. 7), to retrieve data from memory addresses that are in the host memory 145 as specified in storage access requests having the opcode for write operations, and/or to provide data to memory addresses that are in the host memory 145 as specified in storage access requests having the opcode for read operations.

Optionally, the connections 162 and 164 are of different types. For example, in one implementation, the connection 162 is a DDR bus; and the connection 164 is a PCIe bus; and in another implementation, the connection 162 is a PCIe bus or CXL connection; and the connection 164 is a network connection. Optionally, the connection 162 can be configured to have a higher bandwidth and a lower latency in communications than the connection 164. Alternatively, the connections 162 and 164 can be of a same type (e.g., a PCIe or CXL connection) and/or can be used interchangeably for memory access and for storage access.

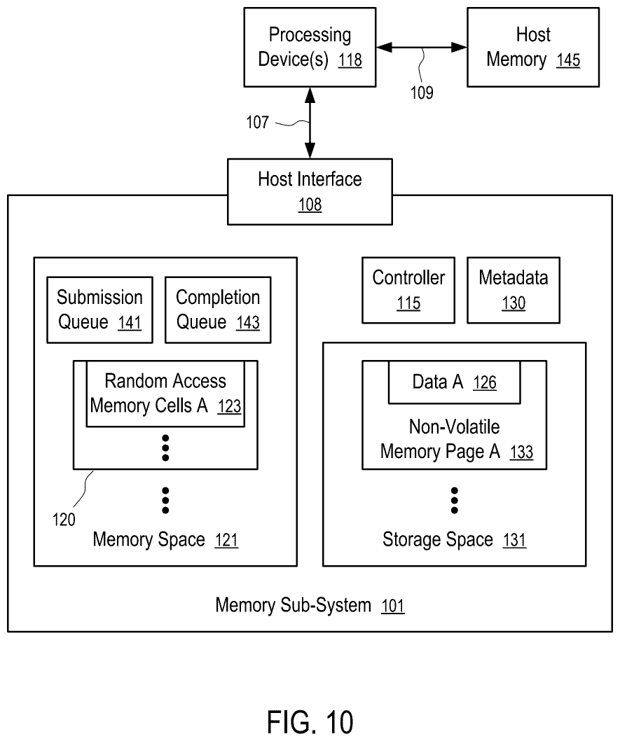

Alternatively, the memory access and the storage access can be made using a same interface over a same connection (e.g., a PCIe bus or CXL connection) to the host system 102, as in FIG. 10.

In FIG. 10, a host interface 108 is configured to allow the processing device(s) 118 (e.g., a CPU, a GPU, a CPU or GPU core, or a system on a chip (SoC), or an AI accelerator) to access the memory space 121 over a connection 107. The processing device(s) 118 can be configured to specify memory addresses (e.g., 124) used in storage access requests (e.g., 137) in the memory space 121. The submission queue 141 and the completion queue 143 can be both configured in the memory space 121 (e.g., as in FIG. 5). Thus, it is not necessary for the memory sub-system 101 to access the host memory 145; and the host memory 145 can be connected to the processing device(s) 118 via a connection 109 that is separate from the connection 107 between the processing device(s) 118 and the memory sub-system 101. For example, the connection 107 can be a PCIe bus, CXL connection, or a DDR bus.

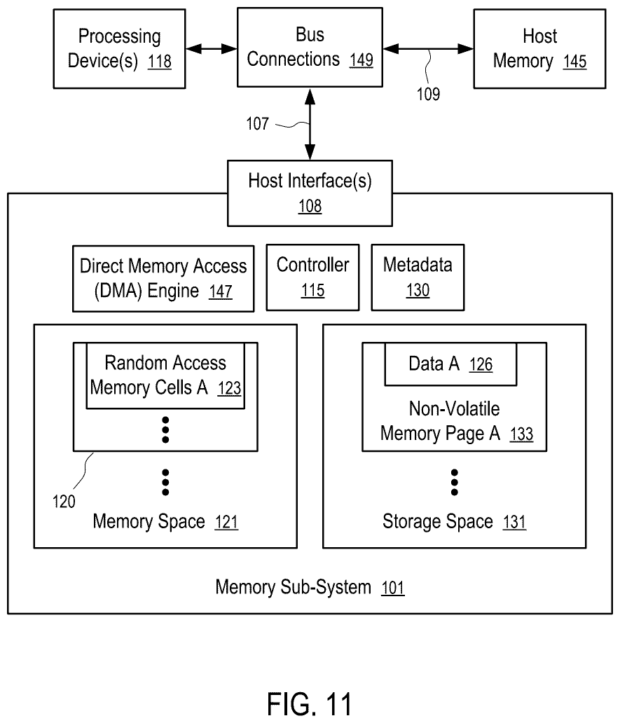

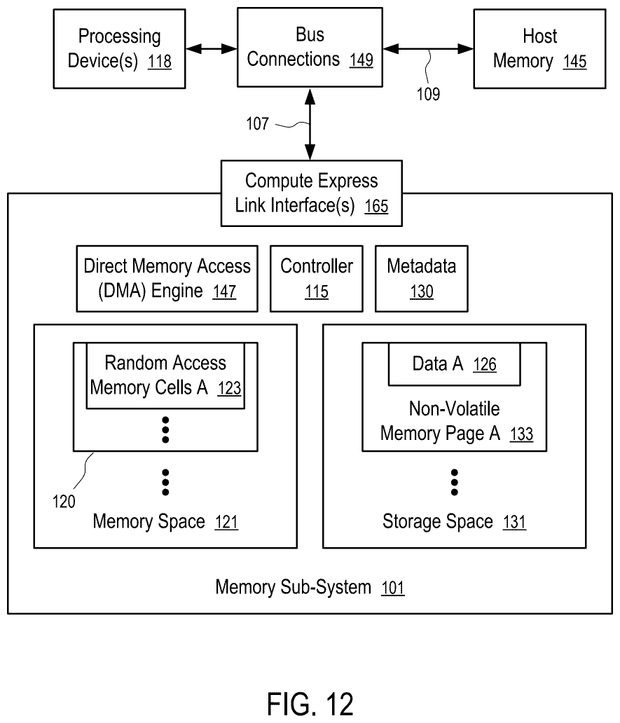

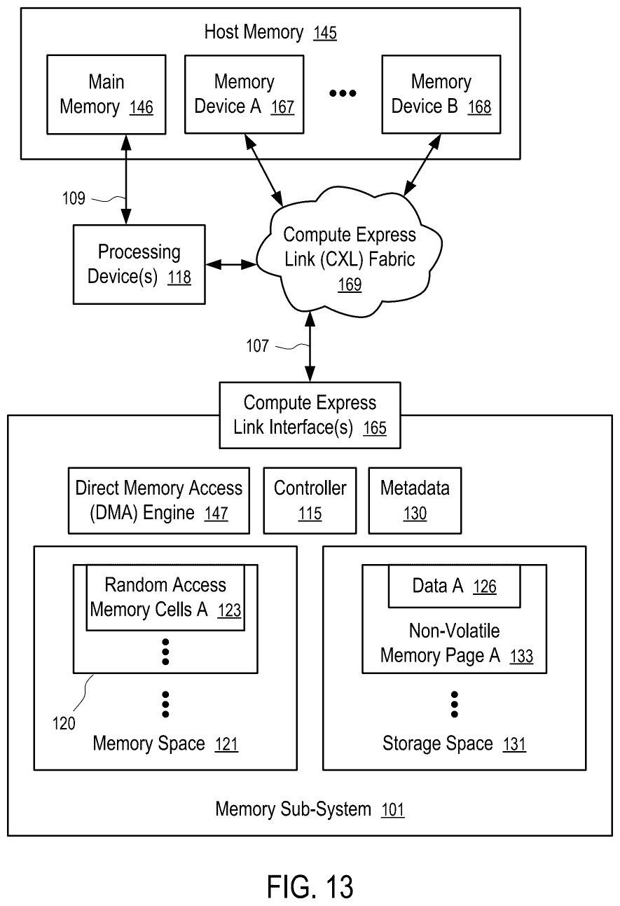

Alternatively, the memory sub-system 101 can be configured to include one or more host interface(s) 108 that can be used by the processing devices 118 to load data from and store data to the memory space 121 and concurrently used by a direct memory access (DMA) engine 147 and/or the controller 115 of the memory sub-system 101 to access the host memory 145, as in FIG. 11, FIG. 12, and FIG. 13.

In FIG. 11, a set of bus connections 149 can be configured to interconnect the processing device(s) 118, the host memory 145, and the host interface(s) 108 of the memory sub-system 101. Since the host interface(s) 108 allows the processing device(s) 118 to load data from and store data to the memory space 121, some submission queues can be configured for the memory sub-system 101 in the memory space 121 of the memory sub-system 101. Optionally, some submission queues and/or completion queues can be configured for the memory sub-system 101 in the host memory 145 outside of the memory sub-system 101. The processing device(s) 118 can configure storage access requests (e.g., 137) to have memory addresses (e.g., 124) in the memory space 121 or in the host memory 145. Thus, the source of the data to be written into the storage space 131 via write commands can be in the memory space 121 or in the host memory 145 during the execution of the write commands (e.g., storage access requests 137); and the destination of the data to be retrieved from the storage space 131 via read commands can be in the memory space 121 or in the host memory 145 during the execution of the read commands (e.g., storage access requests 137).

At least one of the host interface(s) 108 in FIG. 11 can be configured to allow the direct memory access engine 147 of the memory sub-system 101 to access the host memory 145 without assistance from the processing devices 118. Thus, the processing device(s) 118 can optionally configure some storage access requests to have memory addresses in the host memory 145. For example, data to be written into the storage space 131 can be in the host memory 145 for the execution of such storage access requests having opcodes for write operations. For example, data to be retrieved from the storage space 131 can be retrieved into the host memory 145 for the execution of such storage access requests having opcodes for read operations. Further, submission queues and/or completion queues for the memory sub-system 101 can be configured in the host memory 145. The controller 115 and/or the direct memory access (DMA) engine 147 can be configured to access the submission queues and/or completion queues that are in the host memory 145.

In some implementations, the memory sub-system 101 includes multiple host interfaces 108 to allow concurrent access by the processing device(s) 118 to the memory space 121 and by the memory sub-system 101 to the host memory 145. Alternatively, the memory sub-system 101 has a single host interface 108 for a connection (e.g., PCIe or CXL connection) that allows the memory sub-system 101 to the host memory 145 during some time periods and the processing device 118 to access the memory space 121 during other time periods (but not concurrently).

Optionally, the host interface(s) 108 can be compute express link interface(s) 165 as in FIG. 12.

For example, at least one of the compute express link interface(s) 165 in the memory sub-system 101 in FIG. 12 can be configured to allow the memory space 121 to be attached to the processing device 118 as a memory device; and at least one of the compute express link interface(s) 165 in the memory sub-system 101 in FIG. 12 can be configured to allow the DMA engine 147 and/or the controller 115 of the memory sub-system 101 to access at least a portion of the host memory 145. In some implementations, the memory sub-system 101 is configured with a single compute express link interface 165.

In some implementations, the compute express link interface(s) 165 can be connected to a compute express link (CXL) fabric 169 to allow the memory sub-system 101 to access other memory devices connected to the CXL fabric 169, as in FIG. 13.

The host memory 145 in FIG. 13 can include a main memory 146 connected to the processing device(s) 118 via a memory bus 109 (e.g., DDR memory bus). The host memory 145 can further include one or more memory devices 167, . . . , 168 configured outside of the memory sub-system 101 and connected to the memory sub-system 101 and the processing device(s) 118 via a compute express link (CXL) fabric 169. The CXL fabric 169 can interconnect the memory devices 167, . . . , 168, the memory sub-system 101, and the processing device(s) 118 to allow both the memory sub-system 101 and the processing device(s) 118 to access the memory devices 167, . . . , 168 concurrently.

For example, during the boot time of the computing system 100 containing the CXL fabric 169, the memory space 121 can be identified as one of the memory devices connected to the CXL fabric 169 and thus accessible to the processing device 118 using a memory access protocol of CXL. Thus, the physical memory addresses in the memory space 121 in the memory sub-system 101 and in the memory devices 167, . . . , 168 can be added to the memory map 181 of the memory controller 116 of the processing device(s) 118. Optionally, one or more of the memory devices 167, . . . , 168 can each corresponding to a memory space provided by a memory sub-system that is similar to the memory sub-system 101. Optionally, the main memory 146 is separately connected to the processing device(s) 118 (e.g., via a connection 109, such as a DDR memory bus); and the memory sub-system 101 is configured to access the main memory 146 via a memory controller 116 of the processing device(s) 118.

The CXL fabric 169 can include one or more CXL switches; and each of the memory devices 167, . . . , 168 and the memory sub-system 101 can have a separate CXL connection to one of the ports of the CXL switch(es) in the CXL fabric 169. Further, each of the processing device(s) 118 can have a separate CXL connection to one of the ports of the CXL switch(es) in the CXL fabric 169 to access the memory devices on the CXL fabric 169, including the memory devices 167, . . . , 168, and the memory device corresponding to the memory space 121 in the memory sub-system 101. The CXL fabric 169 can support concurrent access by different host processors (e.g., processing device(s) 118, direct memory access (DMA) engine 147, controller 115) to the memory devices on the CXL fabric 169. The memory sub-system 101 can have a plurality of parallel CXL connections 107 to the CXL fabric 169. Thus, while one or more processing devices 118 are accessing the memory space 121 of the memory sub-system 101 using a CXL memory access protocol, the DMA engine 147 of the memory sub-system 101 can use a separate CXL connection to the CXL fabric 169 to access one of the memory devices 167, . . . , 168. Thus, the submission queue 141 and the completion queue 143 of the memory sub-system 101 and/or memory addresses (e.g., 124) used in storage access requests (e.g., 137) in the submission queue 141 can be distributed in the memory devices on the CXL fabric 169, including the memory devices 167, . . . , 168, and the memory device corresponding to the memory space 121 of the memory sub-system 101.

For example, the processing device(s) 118 can configure a submission queue 141 for the memory sub-system 101 in the memory space 121, and/or another submission queue 141 for the memory sub-system 101 in one of the memory devices 167, . . . , 168 outside of the memory sub-system 101. A storage access request 137 entered in a submission queue (e.g., 141) for execution in the memory sub-system 101 can be configured with a memory address 124 in the memory space 121, or in one of the memory devices 167, . . . , 168. Thus, during the execution of the storage access request 137 having an opcode for reading from a logical block address 134, the memory sub-system 101 can retrieve data from the logical block address 134 into the memory space 121, or into the memory devices 167, . . . , 168, in accordance with the memory address 124 provided in the storage access request 137. Similarly, during the execution of the storage access request 137 having an opcode for writing to a logical block address 134, the memory sub-system 101 can retrieve data using the direct memory access (DMA) engine 147, from the memory space 121, or from the memory devices 167, . . . , 168, in accordance with the memory address 124 provided in the storage access request 137 for writing into a memory page 133 represented by the logical block address 134.

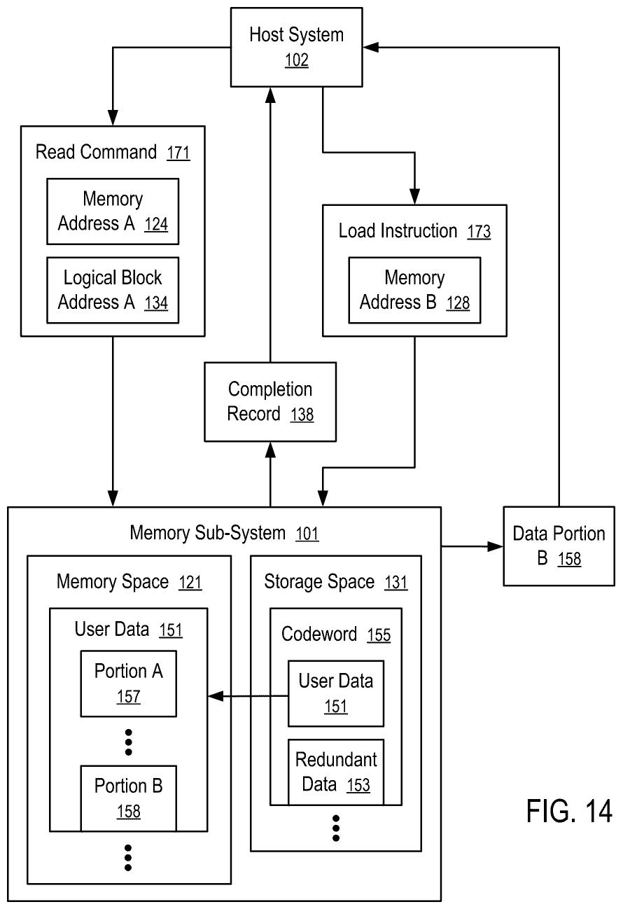

FIG. 14 shows communications to load a portion of data stored at a logical block address in a memory sub-system to a host system according to one embodiment. For example, communications can be implemented in a computing system 100 of FIG. 1 having a memory sub-system 101 according to FIG. 2 to FIG. 8 and connected according to FIG. 9 to FIG. 13.

As illustrated in FIG. 14, to access a portion 158 (e.g., a sub block) of data 151 stored at a logical block address 134 (e.g., an LBA address in accordance with an NVMe standard) in a storage space 131 of the memory sub-system 101, the host system 102 configures a read command 171 to have a memory address 124 in the memory space 121 of the memory sub-system 101, in addition to identifying the logical block address 134 in the storage space 131. The memory address 124 specified in the read command 171 is used to identify the destination location for the retrieval of the data 151 at the logical block address 134.

The host system 102 can send the read command 171 to the memory sub-system 101 using a storage access protocol (e.g., in accordance with an NVMe standard). For example, the host system 102 can enter the read command 171 as a storage access request 137 in a submission queue 141 for retrieval by the memory sub-system 101 (e.g., in accordance with an NVMe standard). For example, the submission queue 141 can be configured in the memory space 121 of the memory sub-system 101 (e.g., as in FIG. 5 or FIG. 7), or in the host memory 145 (e.g., as in FIG. 6). For example, the submission queue 141 can be configured in a memory device (e.g., 167 or 168) connected to a portion of a CXL fabric 169 as in FIG. 13.

The execution of the read command 171 in the memory sub-system 101 causes the memory sub-system 101 to retrieve, from the logical block address 134, a codeword 155 (e.g., encoded using an error correction code technique to have redundant data 153), decode the codeword 155 to determine an error-free version of the user data 151, and store the error-free version of the user data 151 in the memory space 121 according to the memory address 124.

Since the data size 135 of the user data 151 at the logical block address 134 is a multiple of the data size 125 at each memory address (e.g., 124, . . . , 128) in the memory space 121, the user data 151 occupies a plurality of memory addresses (e.g., 124, . . . , 128) in the memory space 121.

After the execution of the read command 171 in the memory sub-system 101, the entire block of user data 151 retrieved from the logical block address 134 is available in the memory space 121 (e.g., as in FIG. 3 to FIG. 8). The memory sub-system 101 can send a completion record 138 to the host system 102 (e.g., in accordance with an NVMe standard) to indicate the availability of the user data 151 in the memory space 121.

For example, the host system 102 can enter the completion record 138 in a completion queue 143 for retrieval by the host system 102. For example, the completion queue 143 can be configured in the memory space 121 of the memory sub-system 101 (e.g., as in FIG. 5), or in the host memory 145 (e.g., as in FIG. 6 or FIG. 7). For example, the completion queue 143 can be configured in a memory device (e.g., 167 or 168) connected to a portion of a CXL fabric 169 as in FIG. 13.

When the completion record 138 indicates a successful execution of the read command 171, any portion (e.g., 157, . . . , 158) in the user data 151 can be loaded from the memory space 121 to the host system 102 via the execution of a load instruction 173 in the host system 102.

For example, in view of the completion record 138 and when the host system 102 is to use a portion 158 (e.g., a sub block) of the data 151 in computation, the host system 102 can execute a load instruction 173 to retrieve the portion 158 of the data 151 from a memory address 128 in the memory space 121. For example, the execution of the load instruction in the host system 102 can cause the memory controller 116 in the host system 102 to load the data portion 158 from the memory address 128 in the memory space 121 of the memory sub-system 101 into the host system 102 using a memory access protocol without loading the remaining portion(s) (e.g., 157) of the data 151.

Thus, the host system 102 can control which portion of the data 151 at the logical block address 134 is to be communicated from the memory sub-system 101 at a time close to when the portion is to be used in computations performed in the host system 102.

Optionally, when the host system 102 is to use the entire block of data 151 at the logical block address 134, the host system 102 can configure the read command 171 to have a memory address 124 that is in the host memory 145, such that the execution of the read command 171 in the memory sub-system 101 can result in the memory sub-system 101 delivering the block of data 151 to the host memory 145. Thus, the host system 102 has the options to configure the read command 171 to have a memory address 124 in the memory space 121 of the memory sub-system 101 or a memory address in the host memory 145 and thus outside of the memory sub-system 101. The host system 102 can select an option from the available options based on how the data 151 is to be used in the computations performed in the host system 102 for optimal performance of the computing system 100 as a whole.

Optionally, the memory space 121 is partitioned into a plurality of memory blocks, each having a size for holding the entire block of data (e.g., 151) stored at one logical block address (e.g., 134) in the storage space 131. The memory address 124 specified in the read command 171 can be used to identify which block of the plurality of predefined/pre-partitioned memory blocks in the memory space 121 is to be used to hold the data (e.g., 151) retrieved from the logical block address (e.g., 134) identified in a read command (e.g., 171). When the memory address 124 specified in the read command 171 does not align with any of the block boundaries of the memory blocks in the memory space 121, the misalignment can be detected as an indication that the beginning portion of the memory block, up to (but not including) the memory address 124, is not to be modified. Thus, the execution of such a read command (e.g., 171) in the memory sub-system 101 can include the memory sub-system 101 retrieving the entire block of data 151 at the logical block address 134, identifying the beginning portion of the data 151 having a size that is equal to the capacity of the beginning portion of the memory block that is not be modified, discarding the beginning portion of the data 151, and storing the remaining portion of the data 151 starting from the memory address 124 identified in the read command (e.g., 171).

Optionally, the read command 171 can include a count of consecutive memory addresses, starting from the memory address 124 specified in the read command 171, as the destination to store at least a portion of the data 151 retrieved from the logical block address 134 in the storage space 131. The block of consecutive memory addresses identified via the read command 171 is configured in one of the plurality of predefined/pre-partitioned memory blocks in the memory space 121. The beginning and/or the end of the consecutive memory addresses identified via the read command 171 can have a misalignment(s) with the beginning and/or the end of the predefined/pre-partitioned memory block that contains the consecutive memory addresses. The misalignment(s) can be detected as an indication that the content at the memory addresses in the predefined/pre-partitioned memory block but outside of the consecutive memory addresses identified via the read command 171 is not to be modified.

For example, when the beginning memory address of the consecutive memory addresses (e.g., the smallest memory address among the consecutive memory addresses) is not the same as the beginning memory address of the memory block (e.g., the smallest memory address in the memory block containing the consecutive memory addresses), the misalignment can cause the memory sub-system 101 to skip storing a beginning portion of the user data 151 into the memory block, where the beginning portion of the user data 151 has the size corresponding to the difference between the beginning memory address of the consecutive memory addresses and the beginning memory address of the memory block.

Similarly, when the ending memory address of the consecutive memory addresses (e.g., the largest memory address among the consecutive memory addresses) is not the same as the ending memory address of the memory block (e.g., the largest memory address in the memory block containing the consecutive memory addresses), the misalignment can cause the memory sub-system 101 to skip storing an ending portion of the user data 151 into the memory block, where the end portion of the user data 151 has the size corresponding to the difference between the ending memory address of the consecutive memory addresses and the ending memory address of the memory block.

Thus, the consecutive memory addresses can be specified by the host system 102 to cause the memory sub-system 101 to store the user data 151 into one of a plurality of predefined/partitioned memory blocks which contains the consecutive memory addresses but only in the consecutive memory addresses by discarding the portion(s) that would be stored in the block but outside of the consecutive memory addresses.

Optionally, the read command 171 can include a field configured to identify the ending memory address of the consecutive memory addresses, in additional to a field configured to identify the beginning memory address (e.g., 124) of the consecutive memory addresses. The memory addresses specified in the fields of the read command 171 identify the consecutive memory addresses selected by the host system 102 to store at least a portion of the user data 151 retrieved from the logical block address 134, where the portion is selected in relation with predefined boundaries of memory blocks in the memory space 121.

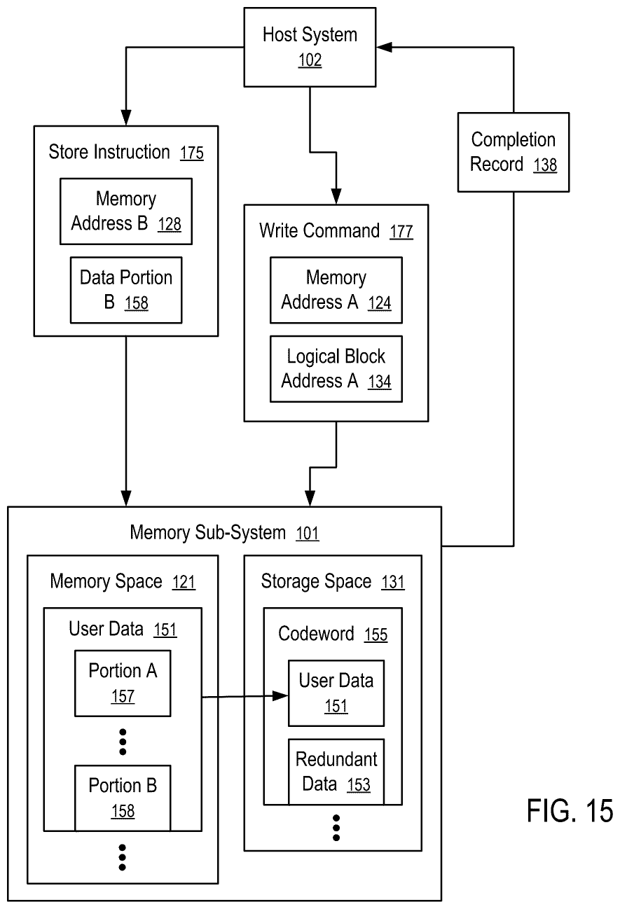

FIG. 15 shows communications to store data from a host system to a logical block address in a memory sub-system according to one embodiment. For example, communications can be implemented in a computing system 100 of FIG. 1 having a memory sub-system 101 according to FIG. 2 to FIG. 8 connected according to FIG. 9 to FIG. 13.

In FIG. 15, the host system 102 is configured to use a memory space 121 in the memory sub-system 101 as a staging ground to build up a block of data 151 to be written to a logical block address 134 in the storage space 131 of the memory sub-system 101.

For example, the host system 102 can use optionally use a read command 171 as in FIG. 14 to retrieve a block of data 151 from the logical block address 134 into the memory space 121 for modification.

For example, the host system 102 can use a store instruction 175 to store a data portion 158 to a memory address 128 in the memory space 121 to modify a corresponding portion (e.g., a sub block) of the block of data 151 previously retrieved via the read command 171 (e.g., as in FIG. 14), and/or to build up the block of data 151 one portion at a time via execution of a plurality of store instructions (e.g., 175). For example, the execution of a store instruction in the host system 102 can cause the memory controller 116 in the host system 102 to store the data portion 158 (e.g., in accordance with a memory access protocol) to the memory address 128 in the memory space 121 of the memory sub-system 101 without communicating the remaining portion (e.g., 157) of the data 151 to the memory sub-system 101.

After the data to be written to the storage space 131 is stored to the memory space 121 via one or more store instructions (e.g., 175), the host system 102 can send to the memory sub-system 101 a write command 177 that specifies a memory address 128 to indicate the source location of the data 151 for writing the data 151 to the storage space 131.

Since the data size 135 of the user data 151 at the logical block address 134 is a multiple of the data size 125 at each memory address (e.g., 124, . . . , 128) in the memory space 121, the user data 151 occupies a plurality of memory addresses (e.g., 124, . . . , 128) in the memory space 121. Thus, the host system 102 can build up the user data 151 in the memory space 121 one portion (e.g., 157, or 158) at a time.

The host system 102 can send the write command 177 to the memory sub-system 101 using a storage access protocol (e.g., in accordance with an NVMe standard). For example, the host system 102 can enter the write command 177 as a storage access request 137 in a submission queue 141 for retrieval by the memory sub-system 101 (e.g., in accordance with an NVMe standard). For example, the submission queue 141 can be configured in the memory space 121 of the memory sub-system 101 (e.g., as in FIG. 5 or FIG. 7), or in the host memory 145 (e.g., as in FIG. 6). For example, the submission queue 141 can be configured in a memory device (e.g., 167 or 168) connected to a portion of a CXL fabric 169 as in FIG. 13.

The execution of the write command 177 in the memory sub-system 101 causes the memory sub-system 101 to generate a codeword 155 from encoding the user data 151 in the memory space 121 (e.g., encoded using an error correction code technique to include the redundant data 153), and program a memory page in the storage space 131 to store the codeword 155.

After the execution of the write command 177 in the memory sub-system 101, the memory sub-system 101 can send a completion record 138 to the host system 102 (e.g., in accordance with an NVMe standard) to indicate the persistent storage of the user data 151 in the storage space 131. Thus, the data 151 in the memory space 121 can be discarded.

For example, the host system 102 can enter the completion record 138 in a completion queue 143 for retrieval by the host system 102. For example, the completion queue 143 can be configured in the memory space 121 of the memory sub-system 101 (e.g., as in FIG. 5), or in the host memory 145 (e.g., as in FIG. 6 or FIG. 7). For example, the completion queue 143 can be configured in a memory device (e.g., 167 or 168) connected to a portion of a CXL fabric 169 as in FIG. 13.

In some implementations, the memory address 124 is configured to represent the beginning memory address of a plurality of consecutive memory addresses 124, . . . , 128 used to provide at least a portion of a block of data 151 to be written to the logical block address 134.

Optionally, when the host system 102 has the entire block of data 151 to be written to the logical block address 134, the host system 102 can configure the write command 177 to have a memory address 124 that is in the host memory 145, such that the execution of the write command 177 in the memory sub-system 101 can result in the memory sub-system 101 retrieving the block of data 151 from the host memory 145. Thus, the host system 102 has the options to configure the write command 177 to have a memory address 124 in the memory space 121 of the memory sub-system 101 or a memory address in the host memory 145 and thus outside of the memory sub-system 101. The host system 102 can select an option from the available options based on how the data 151 is to be generated in the computations performed in the host system 102 for optimal performance of the computing system 100 as a whole.

Optionally, the memory space 121 is partitioned into a plurality of memory blocks, each having a size for holding the entire block of data (e.g., 151) stored at one logical block address (e.g., 134) in the storage space 131. The memory address 124 specified in the write command 177 can be used to identify which block of the plurality of predefined/pre-partitioned memory blocks in the memory space 121 is selected to provide at least a portion of the block of data 151 to be written into the logical block address 134 identified in the write command 177. When the memory address 124 specified in the write command 177 does not align with any of the block boundaries of the memory blocks in the memory space 121, the misalignment can be detected as an indication that the beginning portion of the predefined/pre-partitioned memory block, up to (but not including) the memory address 124, does not contain a corresponding portion of the block of the data 151 to be written to the logical block address 134. Thus, the execution of such a write command (e.g., 177) in the memory sub-system 101 can include the memory sub-system 101 determining the corresponding portion of the block of the data 151 that is not in the memory block identified via the memory address 124. For example, the memory sub-system 101 can determine the corresponding portion, not provided by the host system 102 for the write command 177, via reading the current codeword stored at the logical block address 134, and extracting the corresponding portion based on a difference between the memory address 124 and the beginning of the predefined/pre-partitioned memory block that contains the memory address 124. Alternatively, the corresponding portion of the block of the data 151 that is not in the memory block identified via the memory address 124 can be determined based on filling in the portion with a predetermined value (e.g., zero).

Optionally, the write command 177 can include a count of consecutive memory addresses, starting from the memory address 124 specified in the write command 177, as the source location of at least a portion of the data 151 to be written to the logical block address 134 in the storage space 131. The block of consecutive memory addresses identified via the write command 177 is configured in one of the plurality of predefined/pre-partitioned memory blocks in the memory space 121. The beginning and/or the end of the consecutive memory addresses identified via the write command 177 can have a misalignment(s) with the beginning and/or the end of the predefined/pre-partitioned memory block that contains the consecutive memory addresses. The misalignment(s) can be detected as an indication that the content at the memory addresses in the predefined/pre-partitioned memory block but outside of the consecutive memory addresses identified via the write command 177 does not contain a corresponding portion(s) of the data 151 to be written to the logical block address 134.

For example, when the beginning memory address of the consecutive memory addresses (e.g., the smallest memory address among the consecutive memory addresses) is not the same as the beginning memory address of the memory block (e.g., the smallest memory address in the memory block containing the consecutive memory addresses), the misalignment can cause the memory sub-system 101 to determine a beginning portion of the user data 151 (e.g., via reading the logical block address 134 in the storage space 131 or filling in using a predetermined value), where the beginning portion of the user data 151 has the size corresponding to the difference between the beginning memory address of the consecutive memory addresses and the beginning memory address of the memory block.

Similarly, when the ending memory address of the consecutive memory addresses (e.g., the largest memory address among the consecutive memory addresses) is not the same as the ending memory address of the memory block (e.g., the largest memory address in the memory block containing the consecutive memory addresses), the misalignment can cause the memory sub-system 101 to determine an ending portion of the user data 151 (e.g., via reading the logical block address 134 in the storage space 131 or filling in using a predetermined value), where the end portion of the user data 151 has the size corresponding to the difference between the ending memory address of the consecutive memory addresses and the ending memory address of the memory block.

Thus, the consecutive memory addresses can be specified by the host system 102 to cause the memory sub-system 101 to determine one or more missing portions of the user data 151 (e.g., via reading the logical block address 134 in the storage space 131 or filling in using a predetermined value) and construct the entire block of data 151 from the missing portions and a portion of the user data 151 provided in the consecutive memory addresses.

Optionally, the write command 177 can include a field configured to identify the ending memory address of the consecutive memory addresses, in additional to a field configured to identify the beginning memory address (e.g., 124) of the consecutive memory addresses. The memory addresses specified in the fields of the write command 177 identify the consecutive memory addresses selected by the host system 102 to provide at least a portion of the user data 151 for writing the entire block of the data 151 to the logical block address 134 in the storage space of the memory sub-system 101. When the host system 102 uses the consecutive memory addresses in the memory space 121 to provide only a portion of the user data 151 to be written into the logical block address 134 in the storage space 131, the memory sub-system 101 can automatically determines the remaining portion of the user data 151 (e.g., by reading the current data at the logical block address 134 or filing in with a predetermined number) such that no further communications between the host system 102 and the memory sub-system 101 is necessary for specifying the data in the remaining portion of the user data 151. Alternatively, the host system 102 can use a read command 171 as in FIG. 14 to pre-load the current data at the logical block address 134 into the memory block for modification via the execution of a store instruction(s) (e.g., 175).

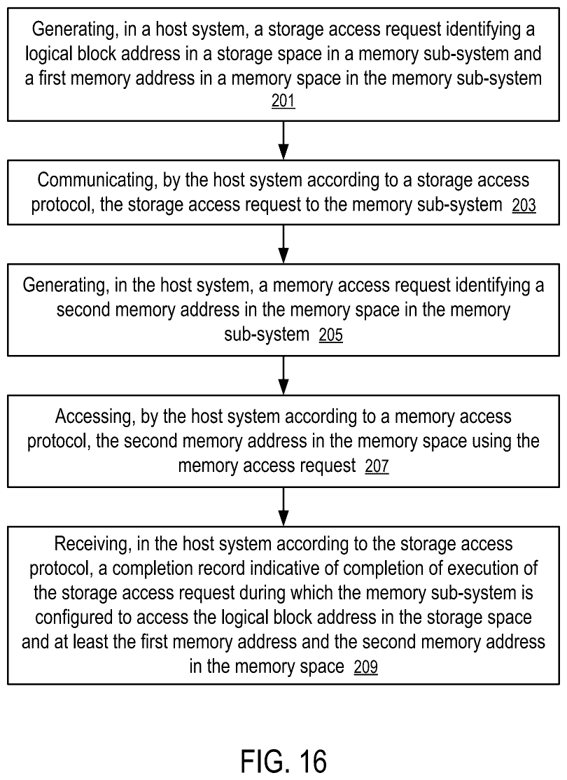

FIG. 16 to FIG. 19 show methods to manage access to a memory space of a memory sub-system and a storage space of the memory sub-system according to some embodiments. The methods of FIG. 16 to FIG. 19 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the methods of FIG. 16 to FIG. 19 are performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method of FIG. 16 can be implemented in a computing system 100 of FIG. 1. For example, the computing system can include a processing device 118 (e.g., a CPU, a GPU, a CPU or GPU core, an SoC, or an AI accelerator), a memory sub-system 101 having a memory space 121 accessible to the processing device 118 via a memory access protocol and a storage space 131 accessible to the processing device 118 via a storage access protocol, and a computer bus 107 configured to connect the memory sub-system 101 to the processing device 118 to provide the memory access and the storage access. For example, the computer bus 107 can be a peripheral component interconnect express (PCIe) bus and/or a compute express link (CXL) connection; the storage access protocol can be in accordance with a standard for non-volatile memory express (NVMe); and the memory access protocol can be over the PCIe bus and/or the CXL connection in accordance with a standard for compute express link (CXL) or a standard for peripheral component interconnect express (PCIe).

For example, the processing device 118 can be configured to generate a storage access request 137 that identifies a logical block address 134 in the storage space 131 and a first memory address 124 in the memory space 121 in the memory sub-system 101. The memory sub-system 101 can be configured to identify, based on the first memory address 124 provided in the storage access request 137 and during the execution of the storage access request 137, a plurality of memory addresses (e.g., 124, . . . , 128) that are consecutive in the memory space 121. If the storage access request 137 includes an opcode for a read operation, the memory sub-system 101 can execute the storage access request 137 to: read data 126 from the logical block address 134, and store the data 126 to the plurality of memory addresses (e.g., 124, . . . , 128) in the memory space 121. If the storage access request 137 includes an opcode for a write operation, the memory sub-system 101 can execute the storage access request 137 to write, to the logical block address 134 in the storage space 131, the data that is provided at the plurality of memory addresses (e.g., 124, . . . , 128) in the memory space 121.

For example, the execution of the storage access request 137 in the memory sub-system 101 can be configured to avoid communications of data over the computer bus 107 to or from the memory sub-system 101. After the execution of the storage access request 137, the memory sub-system 101 can provide a completion record 138 to inform the processing device 118 of the completion status of the execution of the storage access request 137.

For example, the storage access request 137 can be provided by the host system 102 to the memory sub-system 101 using a submission queue 141; and the completion record 138 can be provided by the memory sub-system 101 to the host system 102 using a completion queue 143. For example, the submission queue 141 can be configured in the memory space 121 (e.g., as in FIG. 5 and FIG. 7); and the processing device 118 in the host system 102 can be configured to store the storage access request 137, over the computer bus 107, into the submission queue 141 in the memory sub-system 101 using the memory access protocol. The completion queue 143 can be optionally configured in the memory space 121 in the memory sub-system 101 (e.g., as in FIG. 5), or in a host memory 145 outside of the memory sub-system 101 (e.g., as in FIG. 6 and FIG. 7), for the communication of the completion record 138 from the memory sub-system 101 to the host system 102 according to the storage access protocol (e.g., NVMe).

Optionally, the computing system 100 can further include a random access memory (e.g., host memory 145) configured outside of the memory sub-system 101. A submission queue and a completion queue can be configured for the memory sub-system 101 in the random access memory (e.g., host memory 145) to facilitate the communication of the storage access messages (e.g., a storage access request 137 and a completion record 138). For example, some of the submission queues for storage access requests to be executed in the memory sub-system 101 can be configured in the host memory 145; and one or more submission queues for storage access requests to be executed in the memory sub-system 101 can be configured in the memory space 121 of the memory sub-system 101. Similarly, some of the completion queues for completion records generated by the memory sub-system 101 can be configured in the host memory 145; and one or more completion queues for completion records generated by the memory sub-system 101 can be configured in the memory space 121 of the memory sub-system 101. The storage access requests (e.g., 137) and the completion records (e.g., 138) can have fields and formats as specified in accordance with a storage access protocol (in compliance with an NVMe standard).

At block 201, the method of FIG. 16 includes generating, in a host system 102, a storage access request 137 identifying a logical block address 134 in a storage space 131 in a memory sub-system 101 and a first memory address 124 in a memory space 121 in the memory sub-system 101.

For example, the processing device 118 in the host system 102 can configure the storage access request 137 to identify the logical block address 134 in the storage space 131 in the memory sub-system 101 and the memory address 124 in the memory space 121 in the memory sub-system 101 such that when the storage access request 137 is executed in the memory sub-system 101, the read or write operation performed according to the storage access request 137 does not use the communication bandwidth of the connection 107 from the host interface 108 of the memory sub-system 101 to outside of the memory sub-system 101.

At block 203, the method includes communicating, by the host system 102 according to a storage access protocol, the storage access request 137 to the memory sub-system 101.

For example, the storage access request 137 can be provided by the host system 102 in a submission queue 141 for retrieval by the memory sub-system 101 according to the storage access protocol (e.g., NVMe). After the storage access request 137 is entered in the submission queue 141, the memory sub-system 101 can execute, at a time decided by the memory sub-system 101, the storage access request 137 for reading data from or writing data to the logical block address 134 in the storage space 131. For example, the memory sub-system 101 can decide to execute some of the requests in the submission queue 141 out of the order in which the requests are entered into the submission queue 141.

At block 205, the method includes generating, in the host system 102, a memory access request 127 identifying a second memory address 128 in the memory space 121 in the memory sub-system 101.

For example, the memory access request 127 can be generated, after the storage access request 137 is executed to read data (e.g., 126 or 151) from the logical block address 134, to access the second memory address 128 in the memory space 121 and thus to retrieve a portion 158 of the data (e.g., 126 or 151) from the memory space 121 to the host system 102 without communicating the remaining portion (e.g., 157) of the data (e.g., 126 or 151) across the connection 107 between the memory sub-system 101 and the host system 102 (e.g., as illustrated in FIG. 14). Since the portion 158 of the data (e.g., 126 or 151) is to be retrieved from the memory space 121 of the memory sub-system 101 after the execution of the read operation of the storage access request 137, the execution of the storage access request 137 in the memory sub-system 101 can be performed to save data (e.g., 126 or 151) to the memory space 121 without communication of the data (e.g., 126 or 151) across the connection 107 to or from the memory sub-system 101 during the execution of the storage access request 137.

Alternatively, the memory access request 127 can be generated, before the storage access request 137 is executed to write data (e.g., 126 or 151) to the logical block address 134 (e.g., as illustrated in FIG. 15), to access the second memory address 128 in the memory space 121 and thus to provide a portion 158 of the data (e.g., 126 or 151) from the host system 102 into the memory space 121 such that the portion 158 of the data (e.g., 126 or 151) is not communicated across the connection 107 between the memory sub-system 101 and the host system 102 during the execution of the storage access request 137. Since the portion 158 of the data (e.g., 126 or 151) is provided to the memory space 121 of the memory sub-system 101 before the execution of the write operation of the storage access request 137, the execution of the storage access request 137 in the memory sub-system 101 can be performed using data (e.g., 126 or 151) in the memory space 121 without communication of the data (e.g., 126 or 151) across the connection 107 to or from the memory sub-system 101 during the execution of the storage access request 137.

At block 207, the method includes accessing, by the host system 102 according to a memory access protocol (e.g., PCIe or CXL), the second memory address 128 in the memory space 121 using the memory access request 127.

For example, the storage access request 137 (e.g., a read command according to NVMe) generated by the host system 102 can further identify an opcode for a read operation in the memory sub-system 101; and the execution of the storage access request 137 in the memory sub-system 101 includes retrieving data from the logical block address 134 into a plurality of memory addresses (e.g., 124, . . . , 128) in the memory space 121, including the first memory address 124 and the second memory address 128.

For example, a beginning portion 157 of a block of data (e.g., 126 or 151) retrieved from the logical block address 134 in the storage space 131 in the memory sub-system 101 can be stored into the first memory address 124; a subsequent portion of the block can be stored into a memory address that is one increment larger than the first memory address 124; etc. Thus, the block of data (e.g., 126 or 151) is stored into a plurality of consecutive memory addresses in the memory space 121 in the memory sub-system 101, starting with the first memory address 124. The second memory address 128 specified in the memory access request 127 can be different from the first memory address 124 specified in the storage access request 137. For example, the second memory address 128 can be selected for use in the memory access request 127 to load a selected sub block (e.g., portion 158) of the block of data (e.g., 126 or 151) from the memory sub-system 101 to the host system 102. Since the destination of the read command (e.g., the storage access request 137 having the read opcode) is configured in the memory space 121 in the memory sub-system 101, the execution of the storage access request 137 in the memory sub-system 101 communicates no data from the memory sub-system 101 to outside of the memory sub-system 101, which provides an opportunity for the host system 102 to load one or more selected portions (e.g., 158) across the connection 107 via execution of one or more load instructions (e.g., 173) without communications of remaining portions of the block of data (e.g., 126 or 151) across the connection 107.

For example, the storage access request 137 (e.g., a write command according to NVMe) generated by the host system 102 can further identify an opcode for a write operation in the memory sub-system 101; and the execution of the storage access request 137 in the memory sub-system 101 can include programming memory cells in a memory page 133 corresponding to the logical block address 134 (e.g., according to metadata 130 stored in the memory sub-system 101) to store data (e.g., 126 or 151) provided at a plurality of memory addresses 124, . . . , 128 in the memory space 121, including the first memory address 124 and the second memory address 128.

For example, a beginning portion 157 of a block of data (e.g., 126 or 151) to be written to the logical block address 134 in the storage space 131 in the memory sub-system 101 can be obtained from the first memory address 124 in the memory space 121 in the memory sub-system 101; a subsequent portion of the block can be obtained from a memory address that is one increment larger than the first memory address 124; etc. Thus, the block of data (e.g., 126 or 151) to be written to the logical block address 134 can be provided a portion at a time into a plurality of consecutive memory addresses in the memory space 121 in the memory sub-system 101, starting with the first memory address 124. The second memory address 128 can be different from the first memory address 124, and be used to store a selected sub block (e.g., portion 158) of the block of data (e.g., 126 or 151) from the host system 102 into the memory space 121 of the memory sub-system 101.

When the memory access request 127 is used to access, at block 207, the second memory address 128 to provide a selected portion 158 of the block of data (e.g., 126 or 151) to be written to the logical block address 134 via the execution of the storage access request 137 communicated at block 207, the accessing at block 207 is to be scheduled before the execution of the storage access request 137 in the memory sub-system 101. For example, the accessing at block 207 can be performed before the communicating at block 203 of the storage access request 137 having the opcode for the write operation such that the execution of the storage access request 137 occurs after the accessing at block 207 to provide the data used in the execution of the storage access request 137.

In contrast, when the memory access request 127 is used to access, at block 207, the second memory address 128 to obtain a selected portion 158 of the block of data (e.g., 126 or 151) to be retrieved from the logical block address 134 via the execution of the storage access request 137 communicated at block 203, the accessing at block 207 is to be scheduled after the execution of the storage access request 137. For example, the accessing at block 207 can be performed after the receiving, at block 209, a completion record 138 for the storage access request 137 having the opcode for the read operation.

Thus, depending on the opcode specified in the storage access request 137 generated at block 201, a preferred order of the operations at blocks 201 to 209 can be different from what is shown in FIG. 16.

At block 209, the method includes receiving, in the host system 102 according to the storage access protocol (e.g., NVMe), a completion record 138 indicative of completion of execution of the storage access request 137 during which the memory sub-system 101 is configured to access the logical block address 134 in the storage space and at least the first memory address 124 and the second memory address 128 in the memory space 121.

For example, during the execution of the storage access request 137 having a read opcode, the memory sub-system 101 stores the block of data (e.g., 126 or 151) retrieved from the logical block address 134 into a plurality of consecutive memory addresses in the memory space 121, starting from the first memory address 124 as specified in the storage access request 137 and including the second memory address 128.

For example, during the execution of the storage access request 137 having a write opcode, the memory sub-system 101 writes to the logical block address 134 the block of data (e.g., 126 or 151) retrieved from a plurality of consecutive memory addresses in the memory space 121, starting from the first memory address 124 as specified in the storage access request 137 and including the second memory address 128.

For example, after the communicating of the storage access request 137 having the read opcode (at block 203), the host system 102 can check the completion queue 143 for the completion record 138 associated with the storage access request 137. After the host system 102 receives (at block 209), from the completion queue 143, the completion record 138 for the execution the storage access request 137, the host system 102 can determine that the data 126 being read from the logical block address 134 is ready for access in the memory space 121. In response, the host system 102 can generate (at block 205) the memory access request 127 (e.g., via execute a load instruction) and access (at block 207) the second memory address (e.g., 128) to obtain a portion (e.g., 158) of the data 126 that becomes available at the second memory address 128 after the execution of the storage access request 137.

In some implementations, when the storage access request 137 is generated at block 201 to have the write opcode, the operations at blocks 205 and 207 are performed before blocks 201 and/or 203. For example, the accessing at block 207 is to store a portion 158 of the data into the second memory address 128 (e.g., via execution of a store instruction 175 in the processing device 118). When the storage access request 137 is executed in the memory sub-system 101 to program memory cells in a memory page 133 identified by the logical block address 134, at least the portion 158 of the data (e.g., 126 or 151) to be programmed into the memory cells is readily available in the memory space 121 at the second memory address 128.

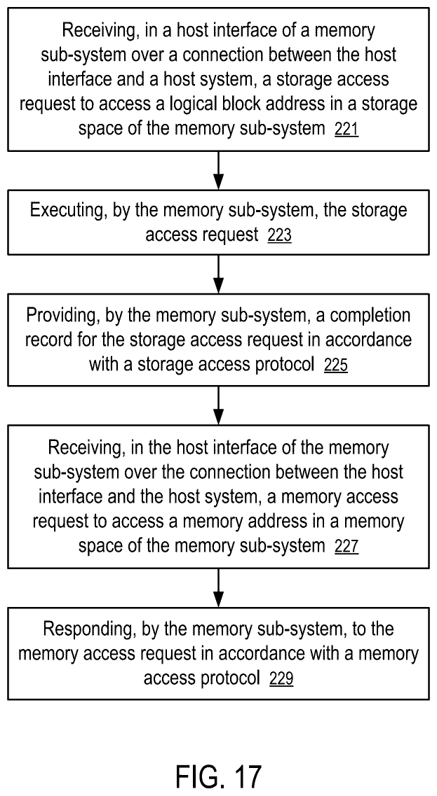

The method of FIG. 17 can be implemented in a memory sub-system 101 of a computing system 100 of FIG. 1. For example, the memory sub-system 101 can have a host interface 108 operable on a connection 107 from the host interface 108 to a host system 102 that is configured outside of the memory sub-system 101. The memory sub-system 101 can have random access memory cells 123 configured to provide a memory space 121 accessible to the host system 102 over the connection 107 via a memory access protocol (e.g., PCIe or CXL). The memory sub-system 101 can have non-volatile memory cells (e.g., in the non-volatile memory page 133) configured to provide a storage space 131 accessible to the host system 102 over the same connection 107 via a storage access protocol (e.g., NVMe). The memory sub-system 101 can have a controller 115 configured to execute a storage access request 137, received from the host system 102 over the connection 107 according to the storage access protocol (e.g., NVMe), to read data (e.g., 126 or 151) into the memory space 121 from a logical block address 134 in the storage space 131. Further, the controller 115 can execute a storage access request 137, received from the host system 102 over the connection 107 according to the storage access protocol (e.g., NVMe), to write data (e.g., 126 or 151) available in the memory space 121 to the logical block address 134 in the storage space 131. Furthermore, the controller 115 can execute a storage access request, received according to the storage access protocol, to read data into a memory device (e.g., 167 or 168, or host memory 145) configured outside of the memory sub-system 101 from the logical block address 134 in the storage space 131, and/or to write data available in the memory device to the logical block address 134 in the storage space 131. For example, the memory sub-system 101 can include a direct memory access (DMA) engine 147 configured to store data over the connection 107 to the memory device during execution of write commands (e.g., storage access requests in compliance with NVMe) and to load data over the connection 107 from the memory device during execution of read commands (e.g., storage access requests in compliance with NVMe).

For example, the random access memory cells 123 can be dynamic random access memory (DRAM) or static random access memory (SRAM); the non-volatile memory cells in the memory page 133 can be NAND or NOR flash memory; the storage access protocol is in accordance with a standard for non-volatile memory express (NVMe); and the memory access protocol is in accordance with a standard for compute express link (CXL) or a standard for peripheral component interconnect express (PCIe).

For example, the memory sub-system 101 can include an error correction code circuit 159 configured to generate codewords (e.g., 155) for storing data (e.g., 126 or 151) in the non-volatile memory cells in the memory page 133. The size (e.g., 135) of each of the codewords (e.g., 155) can be larger than a size (e.g., 125) of the data portion (e.g., 157 or 158) at each of the plurality of memory addresses 124, . . . , 128 in the memory space 121.

At block 221, the method of FIG. 17 includes receiving, in a host interface 108 of a memory sub-system 101 over a connection 107 between the host interface 108 and a host system 102, a storage access request 137 to access a logical block address 134 in a storage space 131 of the memory sub-system 101.

For example, the connection 107 can be a peripheral component interconnect express (PCIe) bus or a compute express link (CXL) connection.

Optionally, a submission queue 141 is configured in the memory space 121 (e.g., as in FIG. 5 and FIG. 7). The receiving of the storage access request 137 at block 221 can include receiving one or more memory access requests over the connection 107 for the host system 102 to store the storage access request 137 in the submission queue 141 configured in the memory space 121 of the memory sub-system 101. For example, the host system 102 can use a memory access protocol (e.g., PCIe or CXL) to store the storage access request 137 into the submission queue 141 in the memory space 121 of the memory sub-system 101 via execution of one or more store instructions.

Alternatively, the submission queue 141 can be configured in the host memory 145 (e.g., as in FIG. 6). The memory sub-system 101 can use the memory access protocol (e.g., PICe or CXL) to load content from the submission queue 141 in the host memory 145 to determine the storage access request 137.

At block 223, the method includes executing, by the memory sub-system 101, the storage access request 137.

For example, execution of the storage access request 137 in the memory sub-system includes reading from or writing to the logical block address 134 a data block (e.g., data 126 or 151) but includes no communication of any portion of the data block between the host system 102 and the memory sub-system 101 during the execution of the storage access request 137. For example, the storage access request 137 can include a memory address 124 in the memory space 121 of the memory sub-system 101 to cause the memory sub-system 101 to execute the storage access request 137 to transport, within the memory sub-system 101, data (e.g., 126 or 151) between the memory space 121 and the storage space 131.

For example, the storage access request 137 can include an opcode for a read operation according to NVMe; and since the storage access request 137 is configured to cause the memory sub-system 101 to read data from the storage space 131 to the memory space 121, no portion of the data block (e.g., data 126 or 151) is communicated between the host system 102 and the memory sub-system 101 during the execution of the storage access request 137. During the execution of the storage access request 137, the data at a single logical block address 134 (e.g., an LBA address according to NVMe) is read into the memory space 121 at a plurality of memory addresses 124, . . . , 128 identified via the storage access request 137; and since the memory access protocol (e.g., PCIe or CXL) is usable by the host system 102 to selectively access any of the plurality of memory addresses 124, . . . , 128 (e.g., as in the method of FIG. 16), the host system 102 has the opportunities to load data from one or more of the memory addresses 124, . . . , 128 but not the remaining portion of the data at other memory addresses.

For example, the storage access request 137 can include an opcode for a write operation according to NVMe; and since the storage access request 137 is configured to cause the memory sub-system 101 to write the data block (e.g., data 126 or 151) from the memory space 121 to the storage space 131, no portion of the data block (e.g., data 126 or 151) is communicated between the host system 102 and the memory sub-system 101 during the execution of the storage access request 137.

At block 225, the method includes providing, by the memory sub-system 101, a completion record 138 for the storage access request 137 in accordance with a storage access protocol (e.g., in accordance with a standard for non-volatile memory express (NVMe)).

Optionally, a completion queue 143 is configured in a host memory 145 located outside of the memory sub-system 101 (e.g., as in FIG. 6 and FIG. 7); and the providing of the completion record 138 at block 225 includes storing, via one or more memory access requests over the connection 107, the completion record 138 in the completion queue 143 configured in the host system 102 and thus outside of the memory sub-system 101. Alternatively, the completion queue 143 is configured in the memory space 121 (e.g., as in FIG. 5).

At block 227, the method includes receiving, in the host interface 108 of the memory sub-system 101 over the connection 107 between the host interface 108 and the host system 102, a memory access request 127 to access a memory address 128 in a memory space 121 of the memory sub-system 101.

At block 229, the method includes responding, by the memory sub-system 101, to the memory access request 127 in accordance with a memory access protocol (e.g., in accordance with a standard for compute express link (CXL) or a standard for peripheral component interconnect express (PCIe)).

For example, the storage access request 137 can include an opcode configured to cause the memory sub-system 101 to read the data block (e.g., data 126 or 151) from the logical block address 134 into the memory space 121 at a plurality of memory addresses 124, . . . , 128; and the responding to the memory access request 127 at block 229 can include providing a data portion 158 of the data block (e.g., data 126 or 151) that is read into the memory space 121 from the logical block address 134 via the execution of the storage access request 137.

For example, the memory access protocol (e.g., PCIe or CXL) can be used by the host system 102 to selectively write data to any of the plurality of memory addresses 124, . . . , 128 (e.g., via the memory request received at block 227) to modify one or more portions of the data block (e.g., data 126 or 151) retrieved via the execution of the storage access request 137. After the modification, the host system 102 can send a further storage access request (e.g., as in FIG. 15) to write the modified data block from the memory space 121 to the storage space 131 (e.g., at the logical block address 134 or another address).

In some instances, the storage access request 137 includes an opcode configured to cause the memory sub-system 101 to write the data block (e.g., data 126 or 151) available in the memory space 121 to the logical block address 134; and the receiving of the memory access request 127 at block 227 can be performed before the executing of the storage access request 137 at block 223 to store, into the memory space 121, a data portion of the data block (e.g., data 126 or 151) that is to be written to the logical block address 134 via the execution of the storage access request 137.

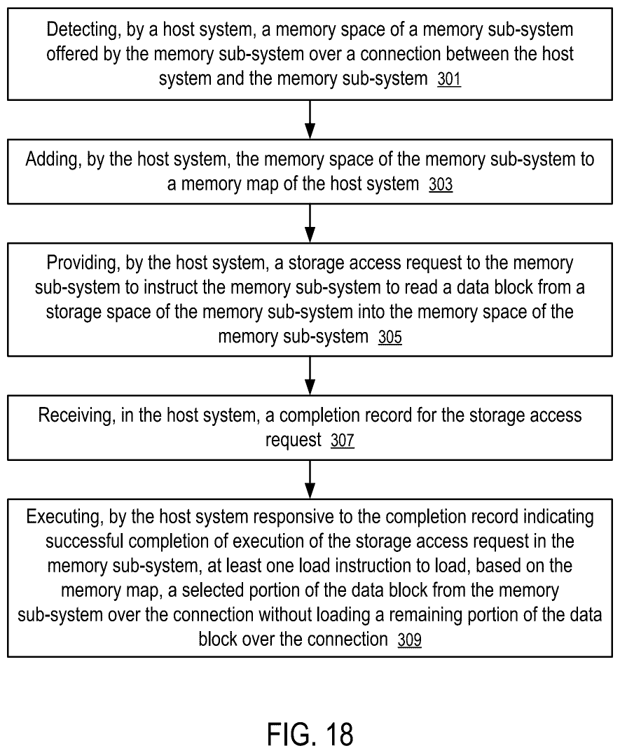

The method of FIG. 18 can be implemented in a host system 102 of a computing system 100 of FIG. 1. For example, the host system 102 can include a memory controller 116 that is operable on a connection 107 from the memory controller 116 to a host interface 108 of a memory sub-system 101; and at least one processing device 118 that is coupled to the memory controller 116. The at least one processing device 118 is configured to: provide a storage access request 137 to the memory sub-system 101 to instruct the memory sub-system 101 to read a data block (e.g., data 126 or 151) from a storage space 131 of the memory sub-system 101 into a memory space 121 of the memory sub-system 101; receive a completion record 138 for the storage access request 137; and execute, responsive to the completion record 138 indicating successful completion of execution of the storage access request 137 in the memory sub-system 101, at least one load instruction to load, based on a memory map 181 in the memory controller 116 identifying the memory space 121 of the memory sub-system 101, a selected portion (e.g., a sub block) of the data block (e.g., data 126 or 151) from the memory sub-system 101 over the connection 107 without loading the remaining portion (e.g., one or more other sub blocks) of the data block over the connection 107.

At block 301, the method of FIG. 18 includes detecting, by a host system 102, a memory space 121 of a memory sub-system 101 offered by the memory sub-system 101 over a connection between the host system 102 and the memory sub-system 101.

At block 303, the method includes adding, by the host system 102, the memory space 121 of the memory sub-system 101 to a memory map 181 of the host system 102.

For example, in response to detecting (e.g., at a boot time of the computing system 100) the memory space 121 offered by the memory sub-system 101, the host system 102 can add the memory space 121 to the memory map 181 of the host system 102 such that the processing devices 118 can access the memory space 121 via executing instructions using virtual memory addresses that are mapped to the physical memory addresses in the memory space 121.

At block 305, the method includes providing, by the host system 102, a storage access request 137 to the memory sub-system 101 to instruct and/or cause the memory sub-system 101 to read a data block (e.g., data 126 or 151) from a storage space 131 of the memory sub-system 101 into the memory space 121 of the memory sub-system 101.

For example, the host system 102 can specify, in the storage access request 137 and as the destination of the read operation, a first memory address 124 that is in the memory space 121 to cause the execution of the storage access request 137 to be an internal operation performed entirely within the memory sub-system 101 (e.g., performed without using any of the host interface(s) 108 of the memory sub-system 101).

At block 307, the method includes receiving, in the host system 102 a completion record 138 for the storage access request 137.

For example, the storage access request 137 (e.g., a read command) and the completion record 138 can be communicated between the host system 102 and the memory sub-system according to a storage access protocol (e.g., NVMe).

For example, the storage access request 137 can be provided by the host system 102 in a submission queue 141 configured for the memory sub-system 101 according to a standard of non-volatile memory express (NVMe); and the completion record 138 can be received by the host system 102 from a completion queue 143 according to the standard of non-volatile memory express (NVMe).

At block 309, the method includes executing, by the host system 102 responsive to the completion record 138 indicating successful completion of execution of the storage access request 137 in the memory sub-system 101, at least one load instruction 173 (e.g., as in FIG. 14) to load, based on the memory map 181, a selected data portion 158 of the data block (e.g., data 126 or 151) from the memory sub-system 101 over the connection 107 without loading a remaining portion of the data block over the connection 107.

For example, the data block (e.g., data 126 or 151) can be read, as a result of the execution of the storage access request 137, into the memory space 121 at a plurality of consecutive memory addresses 124, . . . , 128, starting with the first memory address 124 specified in the storage access request 137; and the load instruction is executed in the host system 102 to load data from a second memory address 128 among the plurality of consecutive memory addresses 124, . . . , 128.

For example, the data block (e.g., data 126 or 151) can be stored at a single logical block address 134 in the storage space 131 of the memory sub-system 101. The storage access request 137 can specify the logical block address 134 to cause the memory sub-system 101 to read the entire data/codeword 155 at the logical block address 134 into the memory space 121 in the memory sub-system 101. During the read operation in the execution of the storage access request 137 (e.g., a read command according to NVMe), the entire data/codeword 155 is read and then decoded, via an error correction code technique (e.g., low-density parity-check (LDPC)). Decoding the single codeword 155 stored at the logical block address 134 in the storage space 131 of the memory sub-system 101 provides the data block (e.g., data 126 or 151) in its entirety. For example, the size of the codeword 155 can be at least 512 bytes; and the selected data portion 158 being loaded from the memory sub-system 101 to the host system 102 can be no more than 128 bytes of the at least 512 bytes of user data 151 decoded from the codeword 155.

Optionally, at least a portion of the data block (e.g., data 126 or 151) read from the logical block address 134 identified in the storage access request 137 is discarded by the memory sub-system 101 and thus not stored into the memory space 121. For example, the determination of which portion of the user data 151 decoded from the codeword 155 is discarded and thus not stored into the plurality of consecutive memory addresses 124, . . . , 128 identified by the storage access request 137 can be based on one or more misalignments of the plurality of consecutive memory addresses 124, . . . , 128 with predefined memory addresses of memory blocks in the memory space 121.

For example, the memory space 121 can be subdivided into a plurality of predefined memory blocks. Each memory block is sufficient to store the entire user data (e.g., 151) decoded from a codeword (e.g., 155) stored at a logical block address (e.g., 134) in the storage space 131. The consecutive memory addresses 124, . . . , 128 identified by the storage access request 137 are configured to be within one of the predefined memory blocks. When the first memory address 124 is the same as the smallest memory address in the memory block containing the memory addresses 124, . . . , 128, the beginning portion of the user data 151 is stored starting from the smallest memory address in the memory block (which is the same as the first memory address 124); and no data from the beginning portion of the user data 151 is discarded. However, when the first memory address 124 is not the same as, and thus misaligned with, the smallest memory address in the memory block containing the memory addresses 124, . . . , 128, the data from the beginning portion of the user data 151 that would be stored starting with the smallest memory address in the memory block up to but not including the first memory address 124 is discarded and not stored into the memory block. Thus, the identification of the first/smallest memory address 124, among the plurality of consecutive memory addresses 124, . . . , 128 identified as the destination of the read operation of the storage access request 137, as misaligned with the smallest memory address in the memory block containing the destination can be considered a request to discard the beginning/leading portion of the user data 151, where the size of the discarded beginning/leading portion of the user data 151 is based on the size of the gap between the smallest memory address in the memory block and the first memory address 124, which is the smallest memory address in the plurality of consecutive memory addresses 124, . . . , 128.

In a similar way, the identification of the largest memory address, among the plurality of consecutive memory addresses (e.g., 124, . . . ) identified as the destination of the read operation of the storage access request 137, as misaligned with the largest memory address in the memory block containing the destination can be considered a request to discard the ending/trailing portion of the user data 151, where the size of the discarded ending/trailing portion of the user data 151 is based on the size of the gap between the largest memory address in the memory block and the largest memory address in the plurality of consecutive memory addresses (e.g., 124, . . . ).

Optionally, the plurality of consecutive memory addresses (e.g., 124, . . . , 128) are identified in the storage access request via a combination of the first memory address 124 as the smallest memory address and a count of the plurality of consecutive memory addresses (e.g., 124, . . . , 128). Alternatively, the plurality of consecutive memory addresses 124, . . . , 128 can be identified in the storage access request via a combination of the first memory address 124 as the smallest memory address and another memory address as the largest memory address in the plurality of consecutive memory addresses (e.g., 124, . . . , 128).

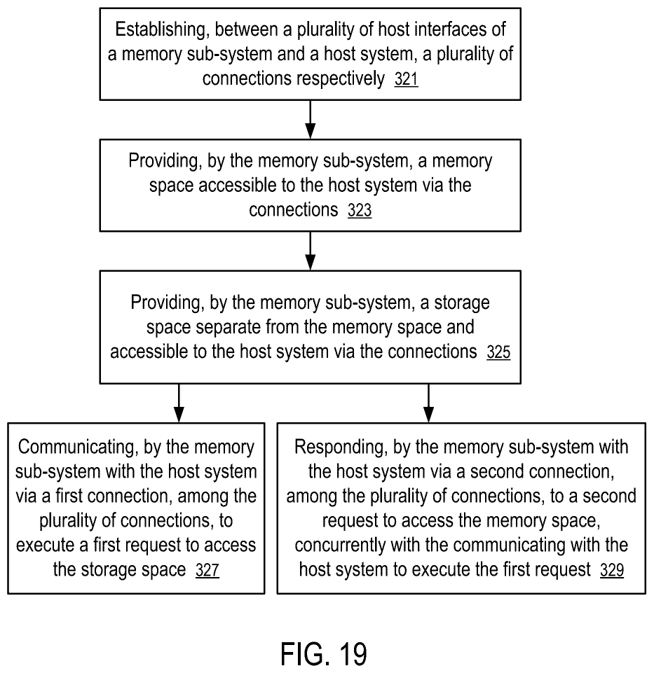

The method of FIG. 19 can be implemented in a memory sub-system 101 of a computing system 100 of FIG. 1. For example, the memory sub-system 101 can include a plurality of host interfaces 108 operable to communicate concurrently over a plurality of connections (e.g., 107; 162, 164) respectively. The memory sub-system 101 can include memory cells 114 configured to provide a memory space 121 accessible to a host system 102 via the connections and a storage space 131 that is separate from the memory space 121 and accessible to the host system 102 via the connections. The memory sub-system 101 can include a controller 115 configured to communicate with the host system 102 via a first connection (e.g., 164), among the plurality of connections, to execute a first request (e.g., 137) to access the storage space 131 and concurrently communicate with the host system 102 via a second connection (e.g., 162), among the plurality of connections, to respond to a second request (e.g., 127) to access the memory space 121.

Optionally, the plurality of host interfaces 108 are interchangeable for storage access and memory access. Optionally, the first connection (e.g., 164) and the second connection (e.g., 162) are interchangeable for storage access and memory access.

For example, the controller 115 can communicate with the host system 102 via the first connection (e.g., 164) to access a host memory 145 in the host system during execution of the first request (e.g., 137) to load data from (or store data to) the host memory 145 for writing to (or reading from) the storage space 131 according to a logical block address 134 specified in the first request (e.g., 137), or to retrieve the first request (e.g., 137) from a submission queue 141 configured in the host memory 145, or to provide a completion record 138 for the first request (e.g., 137) in a completion queue 143 configured in the host memory 145.

For example, the first request (e.g., 137) can be in accordance with a standard for non-volatile memory express (NVMe); and the communicating over the first connection (e.g., 164) and the responding over the second connect (e.g., 162) can be in accordance with a standard for compute express link (CXL) or a standard for peripheral component interconnect express (PCIe).

For example, the memory cells 114 in the memory sub-system 101 can include first memory cells 123 of a first type (e.g., DRAM or SRAM) and second memory cells (e.g., in non-volatile memory page 133) of a second type (e.g., NAND or NOR flash memory); the first memory cells are configured to provide the memory space 121; and the second memory cells are configured to provide the storage space 131.

Optionally, a submission queue 141 for the first request (e.g., 137) is configured in the memory space 121; and the controller 115 can retrieve the first request (e.g., 137) from the submission queue 141 configured in the memory space 121 and/or retrieve other storage access requests from other submission queues configured in the host memory 145.

At block 321, the method of FIG. 19 includes establishing, between a plurality of host interfaces 108 (e.g., interfaces 161 and 163) of a memory sub-system 101 and a host system 102, a plurality of connections 107 respectively.

For example, the memory sub-system 101 can have a memory access interface 161 that allows the host system 102 to access the memory space 121 in the memory sub-system 101 using a memory access protocol (e.g., CXL or PCIe) over a connection 162 (e.g., as illustrated in FIG. 9). When the connection 162 is used to access the memory space 121 in the memory sub-system 101, the host system 102 is the master of the connection 162 and is in control of the connection 162.

For example, the memory sub-system 101 can have a storage access interface 163 that allows the memory sub-system 101 to access a host memory 145 in the host system 102 using a memory access protocol (e.g., CXL or PCIe) over a separate connection 164 (e.g., as illustrated in FIG. 9). When the connection 164 is used to access the host memory 145 in the host system 102, the memory sub-system 101 is the master of the connection 164 and is in control of the connection 164.

Optionally, the interfaces 161 and 163 can be of a same type and/or interchangeable in their usages for accessing the memory space 121 in the memory sub-system 101 by the host system 102 and for accessing the host memory 145 in the host system 102 by the memory sub-system 101.

Optionally, the connections 162 and 164 can go through a set of switches (e.g., one or more CXL switches of a CXL fabric 169 illustrated in FIG. 13) and/or bus connections 149 (e.g., as in FIG. 12). For example, the host memory 145 can include the main memory 145 connected to the processing device(s) 118 in the host system 102 via a double data rate (DDR) memory bus, and/or one or more memory devices 167, . . . , 168.

At block 323, the method includes providing, by the memory sub-system 101, a memory space 121 accessible to the host system 102 via the connections 107.

For example, the memory space 121 can be presented by the memory sub-system 101 as a memory device attachable to the processing device(s) 118 during the boot time of the computing system 100. The host system 102 can add the memory space 121 to its memory map 181 during the boot time for use by the processing device(s) 118.

At block 325, the method includes providing, by the memory sub-system 101, a storage space 131 separate from the memory space 121 and accessible to the host system 102 via the connections.

Optionally, memory access to the memory space 121 and/or the host memory 145 can be configured as synchronous operations, in which a response to a memory access request is provided within a predetermined time period following the access request; and responses to memory access requests are provided in the order of the memory access requests. Storage access to the storage space 131 can be configured as asynchronous operations, in which a response to a storage access request can be provided at a time determined by the memory sub-system 101 without predetermined constraints; and responses to storage access requests can be provided out of order (e.g., in an order different from the order of the storage access requests).

At block 327, the method includes communicating, by the memory sub-system 101 with the host system 102 via a first connection (e.g., 164), among the plurality of connections 107, to execute a first request (e.g., 137) to access the storage space 131.

At block 329, the method includes responding, by the memory sub-system 101 with the host system 102 via a second connection (e.g., 162), among the plurality of connections 107, to a second request (e.g., 127) to access the memory space 121.

The communicating at block 327 and the responding at block 329 can be performed concurrently.

For example, the communicating at block 327 can include accessing, by the memory sub-system 101 via the first connection (e.g., 164), a memory (e.g., 145) in the host system 102 during execution of the first request (e.g., 137) to access the storage space 131, concurrently with the responding at block 329 to the second request (e.g., 127) from the host system 102 over the second connection (e.g., 162).

For example, the first request (e.g., 137) can be a write or read command in accordance with a standard for non-volatile memory express (NVMe); and the accessing of the memory (e.g., 145) in the host system 102 can include loading data from, or storing data to, the memory (e.g., 145) in the host system 102 according to a memory address specified in the first request (e.g., 137) according to a storage access protocol (e.g., NVMe) during execution of the first request (e.g., 137). For example, the memory address can be specified by the host system 102 in the first request (e.g., 137) for writing the data in the host memory 145 into the storage space 131 at a logical block address 134, or for reading the data into the host memory 145 from the logical block address 134 in the storage space 131.

Alternatively, the communicating at block 327 can include accessing, via the first connection (e.g., 164), a memory (e.g., 145) in the host system 102 to retrieve the first request (e.g., 137), concurrently with the responding at block 329 to the second request (e.g., 127) from the host system over the second connection (e.g., 162). For example, after the retrieving of the first request (e.g., 137) from a submission queue 141 configured in the host memory 145 (e.g., as in FIG. 6), the memory sub-system 101 can execute the first request (e.g., 137). If the first request (e.g., 137) includes a memory address 124 in the memory space 121, the method of FIG. 19 can further include: during the execution of the first request (e.g., 137), loading data from, or storing data to, the memory space 121 (internally without using the connections 107 between the host system 102 and the memory sub-system 101) according to the memory address 124 specified in the first request (e.g., 137) according to a storage access protocol (e.g., NVMe). However, if the first request (e.g., 137) includes a memory address in the host memory 145, the method of FIG. 19 can further include: during the execution of the first request (e.g., 137), loading data from, or storing data to, the host memory 145 over the first connection (e.g., 164) according to the memory address specified in the first request (e.g., 137) according to a storage access protocol (e.g., NVMe).

For example, the memory sub-system 101 can be configured to access, via the first connection (e.g., 164), the host memory 145 in the host system 102 to retrieve the first request (e.g., 137) according to a memory access protocol (e.g., in accordance with a standard for compute express link (CXL), or a standard for peripheral component interconnect express (PCIe)). Further, the memory sub-system 101 can be configured to respond at block 329 to the second request (e.g., 127) over the second connection (e.g., 162) in accordance with a memory access protocol (e.g., in accordance with a standard for compute express link (CXL), or a standard for peripheral component interconnect express (PCIe)).

Alternatively, the communicating at block 327 can include accessing, via the first connection (e.g., 164), a memory (e.g., 145) in the host system 102 to provide a completion record 138 for the first request (e.g., 137), concurrently with the responding at block 329 to the second request (e.g., 127) from the host system 102 over the second connection (e.g., 162). For example, a completion queue 143 can be configured in the host memory 145 (e.g., as in FIG. 6 and FIG. 7); and the memory sub-system 101 can store the completion record 138 into the completion queue 143 over the first connection (e.g., 164) while the host system 102 is accessing the memory space 121 using the first connection (e.g., 164).

For example, the second request (e.g., 127) can be used by the host system 102 to load a sub block of data that is previously retrieved by the memory sub-system 101 from the storage space 131 into the memory space 121 during the execution of a previous read command.

For example, the second request (e.g., 127) can be used by the host system 102 to store a sub block of data that can be subsequently programmed by the memory sub-system 101 into the storage space 131 from the memory space 121 during the execution of a next write command.

For example, the second request (e.g., 127) can be used by the host system 102 to enter a next read or write command into a submission queue 141 configured in the memory space 121 (e.g., as in FIG. 5 and FIG. 7), or to retrieve a completion record from a completion queue 143 configured in the memory space 121 (e.g., as in FIG. 5).

A non-transitory computer storage medium can be used to store instructions programmed to implement the access managers 113 in the host system 102 and the memory sub-system 101. When the instructions are executed by the processing device 118, the controller 115, and the processing device 117, the instructions cause the host system 102 and/or the memory sub-system 101 to perform the methods discussed above.

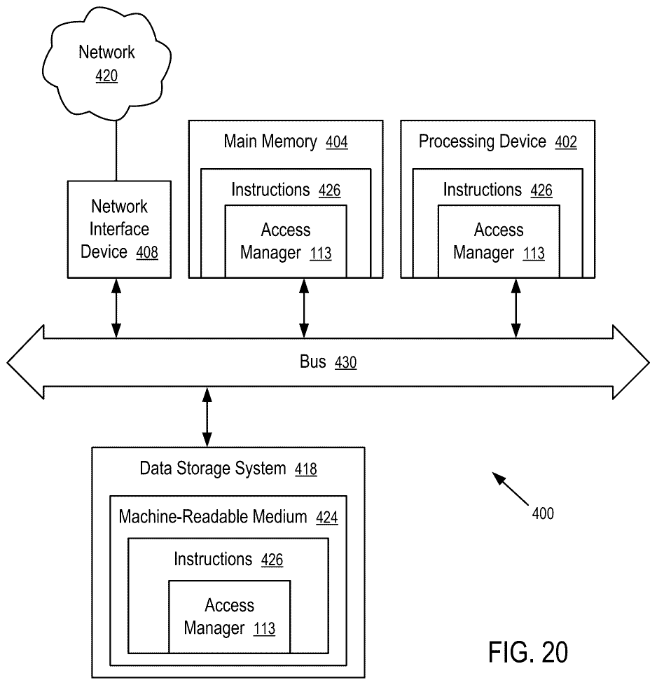

FIG. 20 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of access managers 113 (e.g., to execute instructions to perform operations corresponding to the access managers 113 described with reference to FIGS. 1-19). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the access managers 113 described with reference to FIGS. 1-19. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A memory sub-system, comprising:
a plurality of host interfaces operable to communicate concurrently over a plurality of connections respectively; and
memory cells configured to provide a memory space accessible to a host system via the connections and a storage space separate from the memory space and accessible to the host system via the connections.

2. The memory sub-system of claim 1, further comprising:
a controller configured to communicate with the host system via a first connection, among the plurality of connections, to execute a first request to access the storage space and concurrently communicate with the host system via a second connection, among the plurality of connections, to respond to a second request to access the memory space;
wherein the controller is configured to access, via the first connection, a memory in the host system during execution of the first request to access the storage space, concurrently with responding to the second request from the host system over the second connection.

3. The memory sub-system of claim 2, wherein the controller is configured to load data from, or store data to, the memory in the host system according to a memory address specified in the first request according to a storage access protocol during execution of the first request.

4. The memory sub-system of claim 3, wherein the storage access protocol is in accordance with a standard for non-volatile memory express (NVMe).

5. The memory sub-system of claim 1, wherein the controller is configured to access, via the first connection, a memory in the host system to retrieve the first request, concurrently with responding to the second request from the host system over the second connection.

6. The memory sub-system of claim 5, wherein the controller is configured to load data from, or store data to, the memory space according to a memory address specified in the first request according to a storage access protocol during execution of the first request.

7. The memory sub-system of claim 6, wherein the controller is configured to access, via the first connection, the memory in the host system according to a memory access protocol in accordance with a standard for compute express link (CXL); and the controller is configured to respond to the second request over the second connection in accordance with the standard for compute express link (CXL).

8. The memory sub-system of claim 1, wherein the controller is configured to access, via the first connection, a memory in the host system to provide a completion record for the first request, concurrently with responding to the second request from the host system over the second connection.

9. The memory sub-system of claim 8, wherein the memory cells include first memory cells of a first type and second memory cells of a second type; the first memory cells are configured to provide the memory space; the second memory cells are configured to provide the storage space; and the controller is configured to retrieve the first request from a submission queue configured in the memory space.

10. A method, comprising:
establishing, between a plurality of host interfaces of a memory sub-system and a host system, a plurality of connections respectively;
providing, by the memory sub-system, a memory space accessible to the host system via the connections;
providing, by the memory sub-system, a storage space separate from the memory space and accessible to the host system via the connections; and
communicating, by the memory sub-system with the host system via a first connection, among the plurality of connections, to execute a first request to access the storage space.

11. The method of claim 10, further comprising:
responding, by the memory sub-system with the host system via a second connection, among the plurality of connections, to a second request to access the memory space, concurrently with the communicating with the host system to execute the first request;
wherein the communicating includes accessing, via the first connection, a memory in the host system during execution of the first request to access the storage space, concurrently with the responding to the second request from the host system over the second connection.

12. The method of claim 11, wherein the accessing of the memory in the host system includes loading data from, or storing data to, the memory in the host system according to a memory address specified in the first request according to a storage access protocol during execution of the first request.

13. The method of claim 12, wherein the storage access protocol is in accordance with a standard for non-volatile memory express (NVMe).

14. The method of claim 10, wherein the communicating includes accessing, via the first connection, a memory in the host system to retrieve the first request, concurrently with the responding to the second request from the host system over the second connection.

15. The method of claim 14, further comprising:
loading data from, or storing data to, the memory space according to a memory address specified in the first request according to a storage access protocol during execution of the first request.

16. The method of claim 15, wherein the accessing, via the first connection, the memory in the host system to retrieve the first request is according to a memory access protocol in accordance with a standard for compute express link (CXL); and the responding to the second request over the second connection in accordance with the standard for compute express link (CXL).

17. The method of claim 10, wherein the communicating includes accessing, via the first connection, a memory in the host system to provide a completion record for the first request, concurrently with the responding to the second request from the host system over the second connection.

18. A non-transitory computer storage medium storing instructions which, when executed in a memory sub-system, cause the memory sub-system system to perform a method, comprising:
communicating, by the memory sub-system with a host system via a first connection from a first host interface of the memory sub-system to the host system, to execute a first request to access a storage space of the memory sub-system.

19. The non-transitory computer storage medium of claim 18, wherein the method further comprises:
responding, by the memory sub-system with the host system via a second connection from a second host interface of the memory sub-system to the host system, to a second request to access a memory space of the memory sub-system, concurrently with the communicating with the host system to execute the first request;
wherein the communicating includes one of:
accessing, via the first connection, a memory in the host system during execution of the first request to access the storage space;
accessing, via the first connection, the memory in the host system to retrieve the first request;
accessing, via the first connection, a memory in the host system to provide a completion record for the first request.

20. The non-transitory computer storage medium of claim 19, wherein the first request is in accordance with a standard for non-volatile memory express (NVMe); and the communicating and the responding are in accordance with a standard for compute express link (CXL) or a standard for peripheral component interconnect express (PCIe).
